(19) United States
(12) Patent Application Publication
(10) Pub. No.: US 2023/0131532 A1
(43) Pub. Date: Apr. 27, 2023

(54) USE OF MUSK COMPOUNDS IN FLAVORS

(71) Applicant: PHYTO TECH CORP., Rancho Santa Margarita, CA (US)

(72) Inventors: Katherine Joyce OGLESBY, Rancho Santa Margarita, CA (US); Aaron Jun KAMIMURA, Irvine, CA (US); Sara Guillermina MARINO HERNANDEZ, Mission Viejo, CA (US)

(21) Appl. No.: 17/934,746

(22) Filed: Sep. 23, 2022

Related U.S. Application Data
(60) Provisional application No. 63/248,017, filed on Sep. 24, 2021.

(51) Int. Cl. A23L 27/20; A23L 2/56; A23C 11/06

(52) U.S. Cl. CPC A23L 27/2052; A23L 2/56; A23C 11/06; A23V 2002/00

(57) ABSTRACT

The present disclosure provides methods of flavoring food and beverage products and methods of improving, enhancing, or modifying the fragrance of a fragrant composition by admixing macrocyclic lactone compounds with said products or fragrant compositions.

### BACKGROUND OF THE INVENTION

### Field of Invention

The present disclosure provides compositions comprising cyclic lactones for use in flavoring food or beverage products.

### Background

Cyclic lactone compounds may have a musk-like odor that can be utilized to affect the flavor of food and beverage products. The chemical structure of these compounds can have a large effect on the ultimate flavor and odor of these products. For novel cyclic lactone compounds, there exists a need to determine the optimal formulations and uses of these compounds as flavor additives.

### BRIEF SUMMARY OF THE INVENTION

In one aspect, the disclosure provides food or beverage products comprising one or more compounds of Formula I:

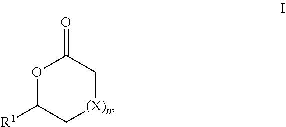

or geometric isomers and/or stereoisomers thereof, wherein:

each X is independently —CH₂—, —CH═CH—CH₂, or —C≡C—CH₂—;

R¹ is C₁-C₆ alkyl;

and n is an integer between 6-30, inclusive.

In one aspect, the disclosure provides methods of flavoring food or beverage products, the methods comprising admixing compositions comprising one or more compounds of Formula I:

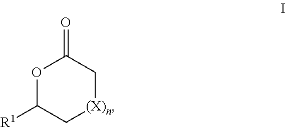

or geometric isomers and/or stereoisomers thereof, wherein:

each X is independently —CH₂—, —CH═CH—CH₂, or —C≡C—CH₂—;

R¹ is C₁-C₆ alkyl;

and n is an integer between 6-30, inclusive,

with the food or beverage products.

Additional embodiments and advantages of the disclosure will be set forth, in part, in the description that follows, and will flow from the description, or can be learned by practice of the disclosure. The embodiments and advantages of the disclosure will be realized and attained by means of the elements and combinations particularly pointed out in the appended claims.

It is to be understood that both the foregoing summary and the following detailed description are exemplary and explanatory only, and are not restrictive of the invention as claimed.

### DETAILED DESCRIPTION OF THE INVENTION

### Food and Beverage Products and Methods of Use

In one embodiment, the disclosure provides food or beverage products comprising one or more compounds of Formula I:

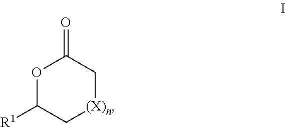

or geometric isomers and/or stereoisomers thereof, wherein:

each X is independently —CH₂—, —CH═CH—CH₂, or —C≡C—CH₂—;

R¹ is C₁-C₆ alkyl;

and n is an integer between 6-30, inclusive.

In one embodiment, the disclosure provides a method of flavoring food or beverage products, the method comprising admixing a composition comprising one or more compounds of Formula I:

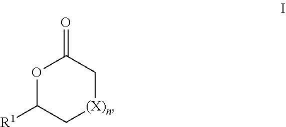

or geometric isomers and/or stereoisomers thereof, wherein:

each X is independently —CH₂—, —CH═CH—CH₂, or —C≡C—CH₂—;

R¹ is C₁-C₆ alkyl

and n is an integer between 6-30, inclusive,

with the food or beverage product.

In another embodiment, the compound of Formula I is racemic, i.e., optically inactive.

In another embodiment, the asymmetric carbon atom the compound of Formula I is in the S configuration.

In another embodiment, asymmetric carbon atom of the compound of Formula I is in the R configuration.

In another embodiment, R¹ is methyl, ethyl, or propyl.

In another embodiment, each X is is independently —CH₂— or —CH═CH—CH₂—.

In another embodiment, each X is —CH₂—.

In another embodiment, one X group is —CH═CH—CH₂— and the remaining X groups are —CH₂—.

In another embodiment, two X groups are —CH═CH—CH₂— and the remaining X groups are —CH₂—.

In another embodiment, three X groups are —CH═CH—CH₂— and the remaining

X groups are —CH₂—.

In another embodiment, four X groups are —CH═CH—CH₂— and the remaining X groups are —CH₂—.

In another embodiment, one X group is —CH═CH—CH₂—, wherein the double bond is an E double bond.

In another embodiment, one X group is —CH═CH—CH₂—, wherein the double bond is an Z double bond.

In another embodiment, two X groups are —CH═CH—CH₂—, wherein one double bond is an E double bond and the other double bond is a Z double bond.

In another embodiment, two X groups are —CH═CH—CH₂—, wherein each double bond is an E double bond.

In another embodiment, two X groups are —CH═CH—CH₂—, wherein each double bond is a Z double bond.

In another embodiment, three X groups are —CH═CH—CH₂—, wherein one double bond is an E double bond and the other double bonds are Z double bonds.

In another embodiment, three X groups are —CH═CH—CH₂—, wherein one double bond is an Z double bond and the other double bonds are E double bonds.

In another embodiment, three X groups are —CH═CH—CH₂—, wherein each double bond is an E double bond.

In another embodiment, three X groups are —CH═CH—CH₂—, wherein each double bond is a Z double bond.

In another embodiment, four X groups are —CH═CH—CH₂—, wherein one double bond is an E double bond and the other double bonds are Z double bonds.

In another embodiment, four X groups are —CH═CH—CH₂—, wherein two double bonds are E double bonds and the other double bonds are Z double bonds.

In another embodiment, four X groups are —CH═CH—CH₂—, wherein three double bonds are E double bonds and the other double bond is a Z double bond.

In another embodiment, four X groups are —CH═CH—CH₂—, wherein each double bond is an E double bond.

In another embodiment, four X groups are —CH═CH—CH₂—, wherein each double bond is a Z double bond.

In another embodiment, n is 6. In another embodiment, n is 7. In another embodiment, n is 8. In another embodiment, n is 9. In another embodiment, n is 10. In another embodiment, n is 11. In another embodiment, n is 12. In another embodiment, n is 13. In another embodiment, n is 14. In another embodiment, n is 15. In another embodiment, n is 16. In another embodiment, n is 17. In another embodiment, n is 18. In another embodiment, n is 19. In another embodiment, n is 20. In another embodiment, n is 21. In another embodiment, n is 22. In another embodiment, n is 23. In another embodiment, n is 24. In another embodiment, n is 25. In another embodiment, n is 26. In another embodiment, n is 27. In another embodiment, n is 28. In another embodiment, n is 29. In another embodiment, n is 30.

In another embodiment, the food or beverage product or the composition comprises a mixture of two or more compounds of Formula I, wherein the compounds have different n values and different R¹ moieties. In another embodiment, the compounds have different n values, different R¹ moieties, and the same R/S configuration at the asymmetric carbon atom. In another embodiment, the compounds have the same n values, the same R¹ moieties, and different R/S configurations at the asymmetric carbon atom. In another embodiment, the compounds have different n values, different R¹ moieties, and different R/S configurations at the asymmetric carbon atom. In another embodiment, the mixture is a racemic mixture of compounds.

In another embodiment, the food or beverage product or the composition comprises one or more compounds of Formula I selected from:

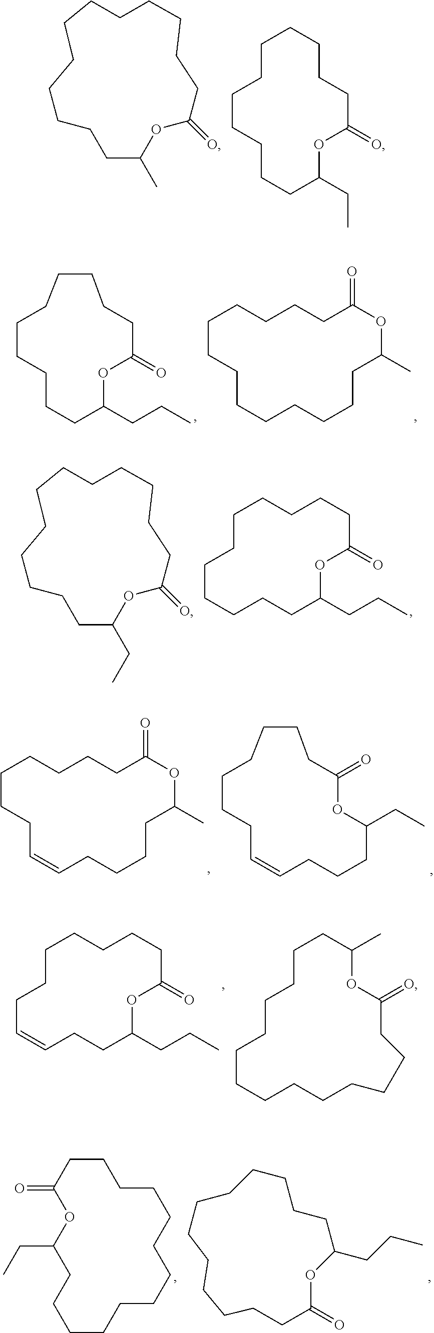

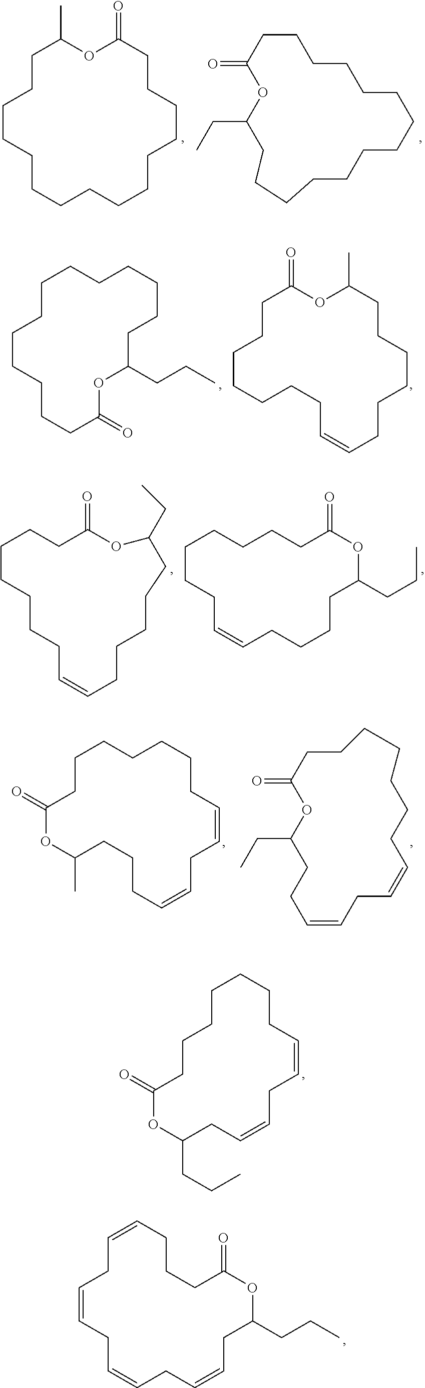

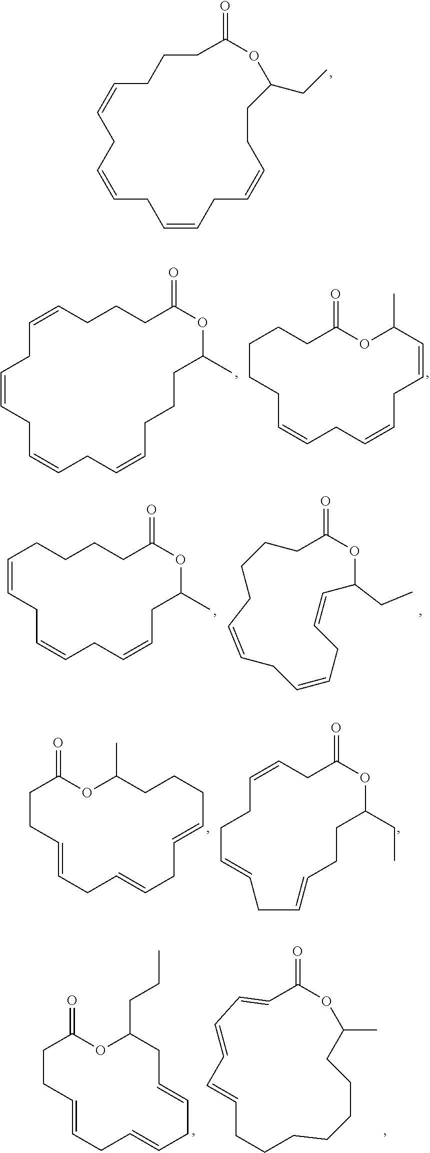

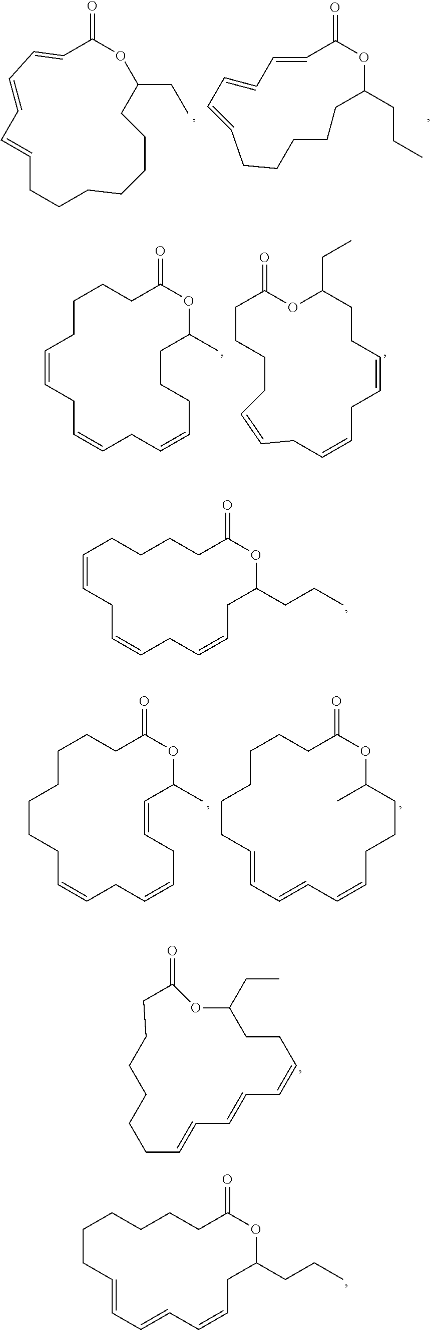

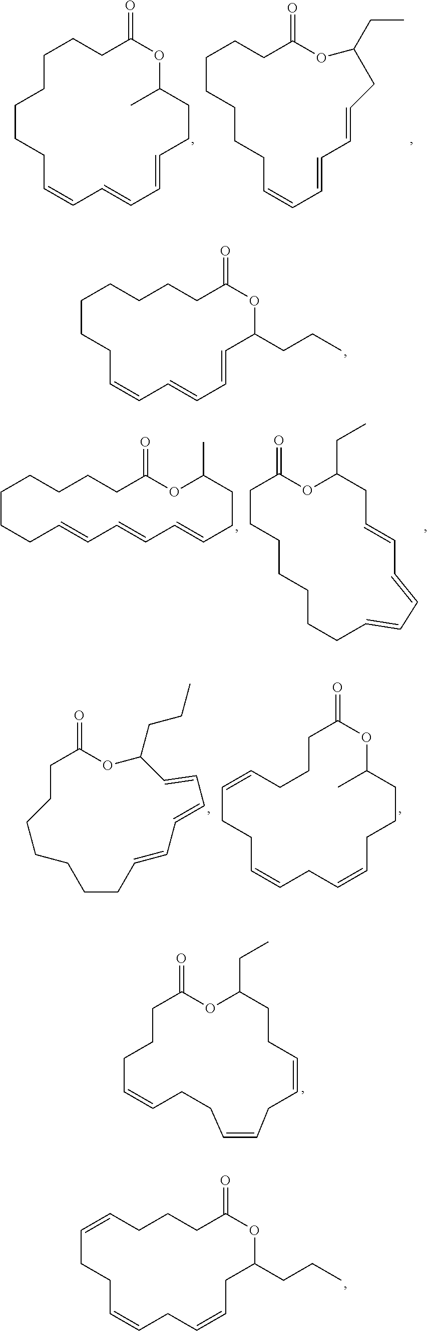

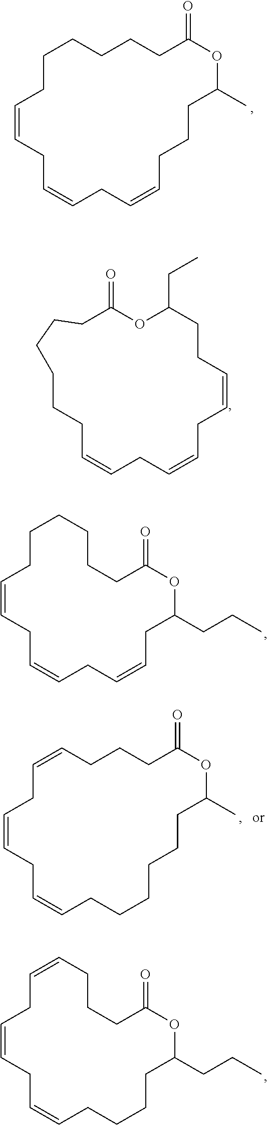

or a combination thereof, or geometric isomers and/or stereoisomers thereof.

In another embodiment, the food or beverage product, or the composition comprises one or more compounds of Formula I selected from:

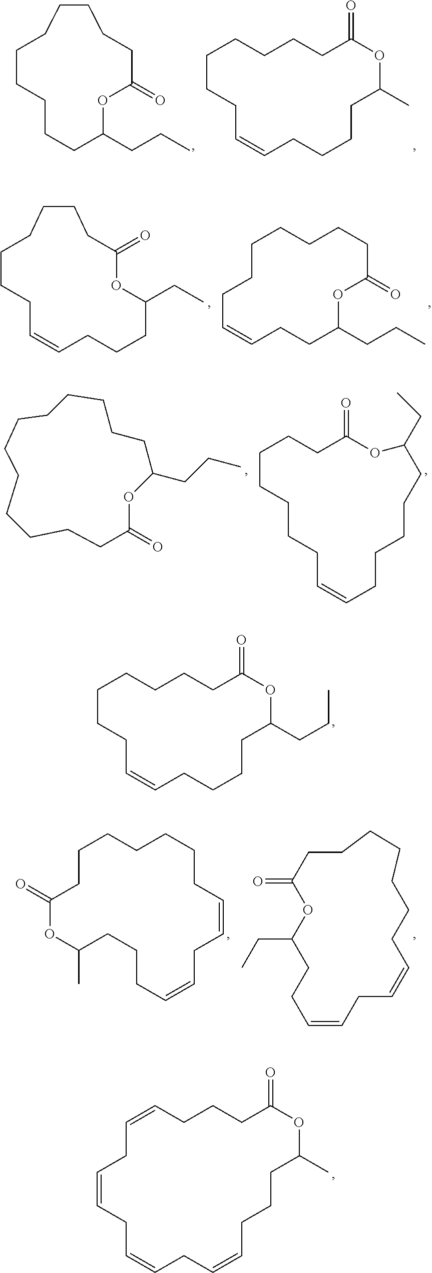

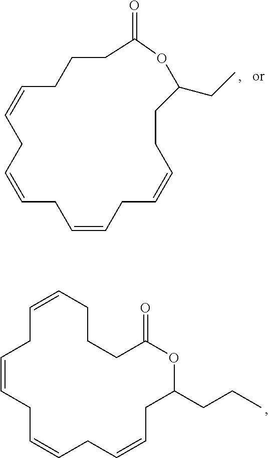 [SMILES: CCC1CC/C=C\C/C=C\C/C=C\C/C=C\CCCC(=O)O1 ; CCCC1C/C=C\C/C=C\C/C=C\C/C=C\CCCC(=O)O1]

or a combination thereof, or geometric isomers and/or stereoisomers thereof.

In another embodiment, the food or beverage product, or the composition comprises one or more compounds of Formula I selected from:

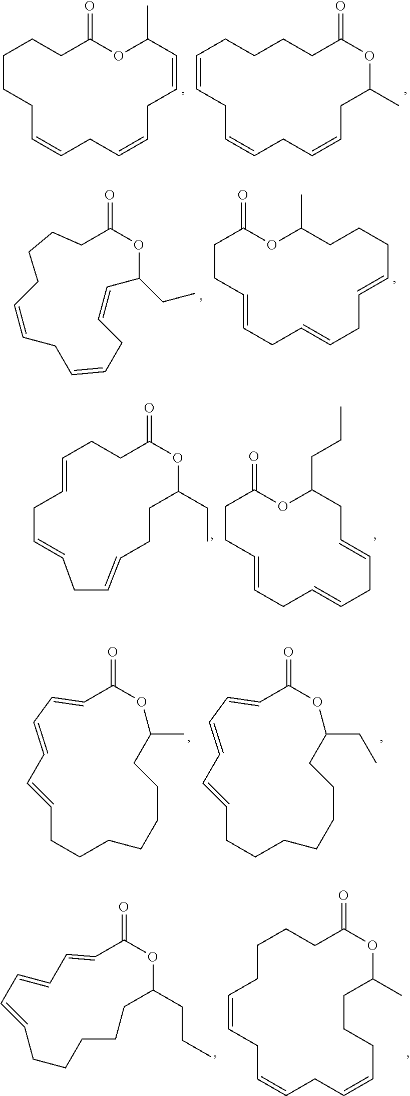

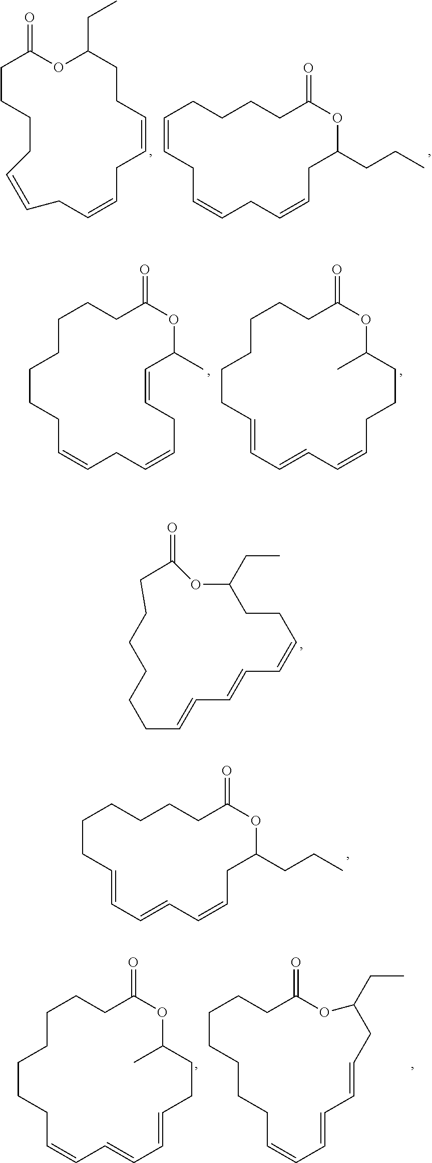

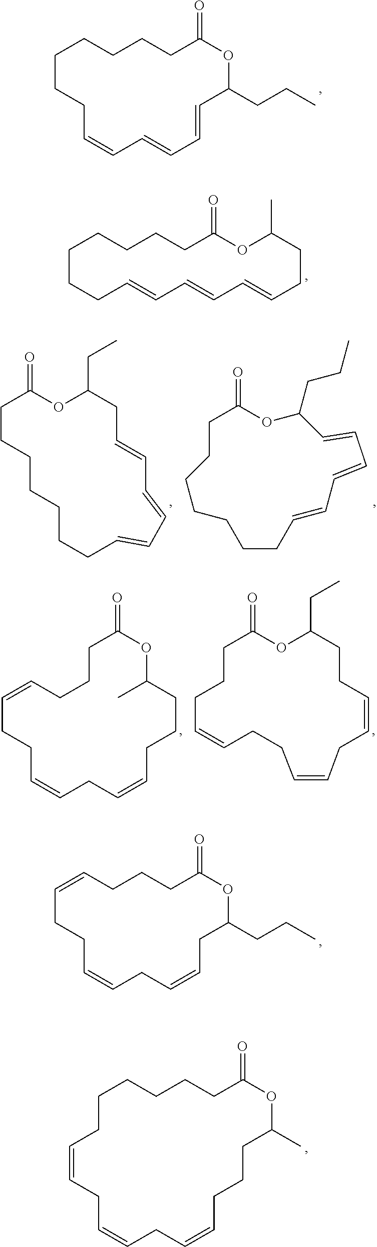

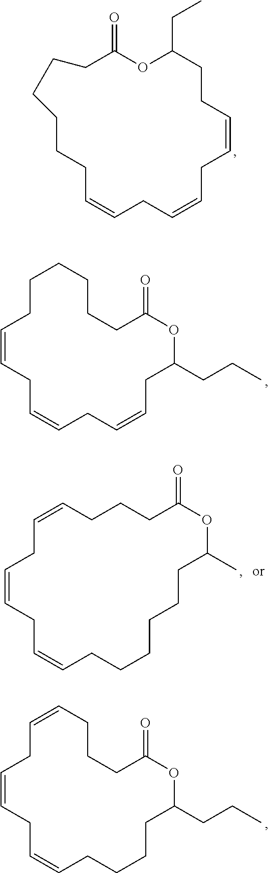

or a combination thereof, or geometric isomers and/or stereoisomers thereof.

In another embodiment, the food or beverage product, or the composition comprises one compound of Formula I.

In another embodiment, the food or beverage product, or the composition comprises two different compounds of Formula I.

In another embodiment, the food or beverage product, or the composition comprises three different compounds of Formula I.

In another embodiment, the food or beverage product, or the composition further comprises a solvent. Solvents include, but are not limited to, water, ethanol, propylene glycol, glycerin, medium chain triglycerides (MCT), vegetable oil, legume oil, or nut oil. Exemplarly oils include, but are not limited to, sunflower oil, olive oil, canola oil, vegetable oil, sesame oil, and avocado oil.

In another embodiment, the solvent comprises ethanol.

In another embodiment, the concentration of each of the one or more compounds of Formula I in the food or beverage product is from about 0.0001% w/w to about 1% w/w. In another embodiment, the concentration of each of the one or more compounds of Formula I in the food or beverage product is from about 0.001% w/w to about 0.01% w/w, e.g., about 0.001% w/w, about 0.0025% w/w, about 0.005% w/w, about 0.0075% w/w, about 0.01% w/w, about 0.025% w/w, about 0.05% w/w, about 0.075% w/w, or about 0.1% w/w.

In another embodiment, the concentration of each of the one or more compounds of Formula I in the composition is from about 0.001% w/w to about 50% w/w. In another embodiment, the concentration of each of the one or more compounds of Formula I in the composition is from about 0.005% w/w to about 0.1% w/w, e.g., about 0.005% w/w, about 0.0075% w/w, about 0.01% w/w, about 0.025% w/w, about 0.05% w/w, about 0.075% w/w, or about 0.1% w/w.

In another embodiment, from about 0.001% w/w to about 5% w/w of the composition is added to the food or beverage product. In another embodiment, from about 0.01% w/w to about 0.5% w/w, e.g., about 0.01% w/w, about 0.025% w/w, about 0.05% w/w, about 0.075% w/w, about 0.1% w/w, about 0.25% w/w, or about 0.5% w/w of the composition is added to the food or beverage product.

In another embodiment, the food or beverage product is an alcoholic or non-alcoholic beverage, a baked good, a confectionary, a meat product, a sauce, a dressing, a condiment, a dairy product, a gelatin product, a plant-based meat product, or a plant-based dairy product.

Alcoholic or non-alcoholic beverages include, but are not limited to, soft drinks, fountain beverages, frozen beverages, ready-to-drink beverages, frozen and ready-to-drink beverages, coffee, tea, powdered soft drinks, liquid concentrates, flavored waters, enhanced waters, sparkling waters, seltzers, fruit juices, fruit juice flavored drinks, sport drinks, energy drinks, isotonic drinks, low-calorie drinks, zero-calorie drinks, vegetable juices, juice drinks, sugar solutions, salt or salt substitute solutions, or hard seltzers.

In another embodiment, the non-alcoholic beverage is a sugar solution.

In another embodiment, the sugar solution further comprises citric acid.

In another embodiment, the non-alcoholic beverage is a 0.1% w/w salt or salt substitute solution.

In another embodiment, the non-alcoholic beverage is sparkling water.

In another embodiment, the alcoholic beverage is a 5% ABV hard seltzer.

Baked goods include, but are not limited to, breads, cakes, pies, biscuits, and cookies.

Confectionaries include, but are not limited to, candies, mints, fruit flavored drops, cocoa products, icings, and chocolates.

Meat products include, but are not limited to, ham, bacon, sausages, jerky, beef patties, and chicken nuggets.

Dressings include Italian dressing, balsamic vinaigrette dressing, Caesar dressing, ranch dressing, Russian dressing, French dressing, Thousand Island dressing, and blue cheese dressing.

Condiments include ketchup, mustard, and mayonnaise.

Dairy products include, but are not limited to, milk, 0% to 20% milk fat, cheese, cream, ice cream, sour cream, yogurt, flavored yogurt, sherbet, egg products, and cultured milk.

In another embodiment, the dairy product is 0% to 20% milk fat.

Gelatin products include, but are not limited to, jams, jellies, preserves, and puddings.

Plant-based meat products include plant-based burgers, plant-based sausages, plant-based nuggets, and plant-based bacon.

Plant based dairy products include almond milk, nut milk, grain milk, legume milk, coconut milk, oat milk, or soy milk.

In another embodiment, the plant-based dairy product is almond milk.

In another embodiment, the food or beverage product further comprises one or more sweeteners. Sweeteners include, but are not limited to, stevia extract, a steviol glycoside, stevioside, rebaudioside B, rebaudioside C, rebaudioside D, rebaudioside F, dulcoside A, rubusoside, steviolbioside, sucrose, high fructose com syrup, fructose, glucose, xylose, arabinose, rhamnose, erythritol, xylitol, mannitol, sorbitol, inositol, AceK, aspartame, neotame, sucralose, saccharine, naringin dihydrochalcone (NarDHC), neohesperidin dihydrochalcone (NDHC), rubusoside, mogroside 20 IV, siamenoside I, mogroside V, monatin, thaumatin, monellin, brazzein, L-alanine, glycine, Lo Han Guo, hemandulcin, phyllodulcin, trilobtain, and combinations thereof. See, e.g., WO 2021/076924.

In another embodiment, the food or beverage product further comprises one or more acids. Acids include, but are not limited to, citric acid, phosphoric acid, malic acid, tartaric acid, folic acid, fumaric acid, and lactic acid.

The term “food product” or “food composition” as used herein includes fruits, vegetables, juices, meat products such as ham, bacon and sausage; egg products, fruit concentrates, gelatins and gelatin-like products such as jams, jellies, preserves, and the like; milk products such as ice cream, sour cream, yogurt, and sherbet; icings, syrups including molasses; corn, wheat, rye, soybean, oat, rice and barley products, cereal products, nut meats and nut products, cakes, cookies, confectionaries such as candies, gums, fruit flavored drops, and chocolates, chewing gum, mints, creams, icing, ice cream, pies and breads. “Food product” also refers to condiments such as herbs, spices and seasonings, flavor enhancers, such as monosodium glutamate. “Food product” further also includes prepared packaged products, such as dietetic sweeteners, liquid sweeteners, tabletop flavorings, granulated flavor mixes which upon reconstitution with water provide non-carbonated drinks, instant pudding mixes, instant coffee and tea, coffee whiteners, malted milk mixes, pet foods, livestock feed, tobacco, and materials for baking applications, such as powdered baking mixes for the preparation of breads, cookies, cakes, pancakes, donuts and the like. “Food product” also includes diet or low-calorie food and beverages containing little or no sucrose.

As used herein, the term “carbohydrate sweetener” includes caloric sweeteners, such as, sucrose, fructose, glucose, high fructose corn syrup (containing fructose and glucose), xylose, arabinose, rhamnose, and sugar alcohols, such as erythritol, xylitol, mannitol, sorbitol, and inositol.

As used herein, the term “flavoring” or the like refers to any food-grade material that may be added to or present in a food or beverage product to provide a desired flavor.

Food and beverage products described herein include any preparations or compositions which are suitable for consumption and are used for nutrition or enjoyment purposes. They are generally products which are intended to be eaten by humans or animals and introduced into the body through the mouth, to remain there for a certain time and then either be eaten (e.g. ready-to-eat foodstuffs or feeds) or removed (e.g. chewing gums). Such products include any substances or products which in the processed, partially processed or unprocessed state are to be ingested by humans or animals.

The food and beverage products according to the disclosure also include substances which in the unchanged, treated or prepared state are to be swallowed by a human or animal and then digested. The expression “food and beverage product” covers ready-to-eat foodstuffs, beverages and feeds, that is to say foodstuffs, beverages or feeds that are already complete in terms of the substances that are important for the taste. The expressions “ready-to-eat foodstuff” and “ready-to-eat feed” also include drinks as well as solid or semi-solid ready-to-eat foodstuffs or feeds. Examples which may be mentioned are frozen products, which must be thawed and heated to eating temperature before they are eaten. Products such as yogurt or ice cream as well as chewing gums or hard caramels are also included among the ready-to-eat foodstuffs or feeds of the current disclosure.

In some embodiments, any one of the food or beverage products described herein further comprises a component selected from the group consisting of sucrose, aroma compounds, flavoring compounds and mixtures thereof. In some embodiments, any one of the food or beverage products described herein further comprises tocopherols in an amount of at least about 5 ppm. In some embodiments, any one of the food or beverage products described herein further comprises at least one stabilizing agent selected from the group consisting of citric acid, sodium benzoate, t-butyl hydroquinone, ascorbyl palmitate, propyl gallate, and combinations thereof. In some embodiments, any one of the food or beverage products described herein further comprises a moisture containing ingredient. In some embodiments, the moisture ingredient is an emulsion. In some embodiments, any one of the food or beverage products described herein further comprises a chelating agent.

Food and beverage products comprising the compositions provided herein may further comprise components selected from the group consisting of additional sweeteners or sweet-tasting compounds, aroma compounds, flavoring compounds, and their mixtures. Such additives may also specifically include hydrocolloids such as pectins, gelatin, carrageenan, or gums (Arabic, guar, locust bean) for dressings, jams, jellies, confections and the like. Other additives to food, feed or beverage products include chelating agents whose addition is designed to protect against enzymatic reactions and may specifically include ethylenediaminetetraacetic acid (EDTA).

Aroma compounds and flavor enhancing agents are well known in the art can be added to the food and beverage products or compositions provided herein. These flavoring agents can be chosen from synthetic flavoring liquids and/or oils derived from plants leaves, flowers, or fruits. Representative flavoring liquids include: artificial, natural or synthetic fruit flavors such as eucalyptus, lemon, orange, banana, grape, lime, apricot, and grapefruit oils, fruit essences including apple, strawberry, cherry, orange, pineapple, and so forth, bean- and nut-derived flavors such as coffee, cocoa, cola, hazelnut, peanut or almond, and root-derived flavors such as licorice or ginger.

The term “C₁₋₆ alkyl” as used herein refers to a straight- or branched-chain aliphatic hydrocarbon containing one to six carbon atoms. Non-limiting exemplary C₁₋₆ alkyl groups include methyl, ethyl, propyl, iso-propyl, butyl, sec-butyl, tert-butyl, iso-butyl, 3-pentyl, and hexyl. In one embodiment, the C₁₋₆ alkyl is methyl. In another embodiment, the C₁₋₆ alkyl is ethyl. In another embodiment, the C₁₋₆ alkyl is propyl. In another embodiment, the C₁₋₆ alkyl is iso-propyl. In another embodiment, the C₁₋₆ alkyl is tert-butyl.

Compounds having Formula I contain an asymmetric carbon atom and may thus give rise to enantiomers, diastereomers, and other stereoisomeric forms. Unless specified otherwise, the present disclosure encompasses the use of all such possible forms, as well as their racemic and resolved forms and mixtures thereof. The individual enantiomers can be separated according to methods known in the art in view of the present disclosure. Compounds of Formula I also contain multiple olefinic double bonds or other centers of geometric asymmetry and, unless specified otherwise, the present disclosure encompasses the use of all such possible geometric forms and mixtures thereof. For example, it is intended that a compound described herein includes both E and Z geometric isomers. All tautomers are also encompassed by the present disclosure.

As used herein, the term “stereoisomers” is a general term for all isomers of an individual molecule that differ only in the orientation of their atoms in space. It includes enantiomers and isomers of compounds with more than one chiral center that are not mirror images of one another (diastereomers).

The term “chiral center” or “asymmetric carbon atom” refers to a carbon atom to which four different groups are attached.

The terms “enantiomer” and “enantiomeric” refer to a molecule that cannot be superimposed on its mirror image and hence is optically active wherein the enantiomer rotates the plane of polarized light in one direction and its mirror image compound rotates the plane of polarized light in the opposite direction.

The term “racemic” refers to a mixture of equal parts of enantiomers and which mixture is optically inactive.

The term “absolute configuration” refers to the spatial arrangement of the atoms of a chiral molecular entity (or group) and its stereochemical description, e.g., R or S.

The stereochemical terms and conventions used in the specification are meant to be consistent with those described in Pure & Appl. Chem 68:2193 (1996), unless otherwise indicated.

The term “enantiomeric excess” or “ee” refers to a measure for how much of one enantiomer is present compared to the other. For a mixture of R and S enantiomers, the percent enantiomeric excess is defined as [R−S]*100, where R and S are the respective mole or weight fractions of enantiomers in a mixture such that R+S=1. With knowledge of the optical rotation of a chiral substance, the percent enantiomeric excess is defined as ([α]_{obs}/[α]ₘₐₓ)*100, where [α]_{obs} is the optical rotation of the mixture of enantiomers and [α]ₘₐₓ is the optical rotation of the pure enantiomer. Determination of enantiomeric excess is possible using a variety of analytical techniques, including NMR spectroscopy, chiral column chromatography, or optical polarimetry.

The use of the terms “a”, “an”, “the”, and similar referents in the context of describing the disclosure (especially in the context of the claims) are to be construed to cover both the singular and the plural, unless otherwise indicated. Recitation of ranges of values herein merely are intended to serve as a shorthand method of referring individually to each separate value falling within the range, unless otherwise indicated herein, and each separate value is incorporated into the specification as if it were individually recited herein. The use of any and all examples, or exemplary language (e.g., “such as”) provided herein, is intended to better illustrate the disclosure and is not a limitation on the scope of the disclosure unless otherwise claimed. No language in the specification should be construed as indicating any non-claimed element as essential to the practice of the disclosure.

The disclosure also provides the following particular embodiments relating to methods and uses comprising a composition comprising a compound of Formula I.

Embodiment I. A method of flavoring a food or beverage product, the method comprising admixing a composition comprising one or more compounds of Formula I:

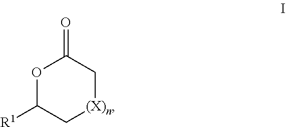

or geometric isomers and/or stereoisomers thereof, wherein:

each X is independently —CH₂—, —CH═CH—CH₂, or —C≡C—CH₂—;

R¹ is C₁-C₆ alkyl; and

is an integer between 6-30, inclusive,

with the food or beverage product.

Embodiment II. The method of Embodiment I, wherein the compound of Formula I is optically inactive.

Embodiment III. The method of Embodiment I, wherein the asymmetric carbon atom of Formula I is in the S configuration.

Embodiment IV. The method of Embodiment I, wherein the asymmetric carbon atom of Formula I is in the R configuration.

Embodiment V. The method of any one of Embodiments I-IV, wherein R¹ is methyl, ethyl, or propyl.

Embodiment VI. The method of any one of Embodiments I-V, wherein each X is independently —CH₂— or —CH═CH—CH₂—.

Embodiment VII. The method of Embodiment VI, wherein each X is —CH₂—.

Embodiment VIII. The method of Embodiment VI, wherein one X group is —CH═CH—CH₂— and the remaining X groups are —CH₂—.

Embodiment IX. The method of Embodiment VI, wherein two X groups are —CH═CH—CH₂— and the remaining X groups are —CH₂—.

Embodiment X. The method of Embodiment VI, wherein three X groups are —CH═CH—CH₂— and the remaining X groups are —CH₂—.

Embodiment XI. The method of Embodiment VI, wherein four X groups are —CH═CH—CH₂— and the remaining X groups are —CH₂—.

Embodiment XII. The method of Embodiment I, wherein the one or more compounds of Formula I are:

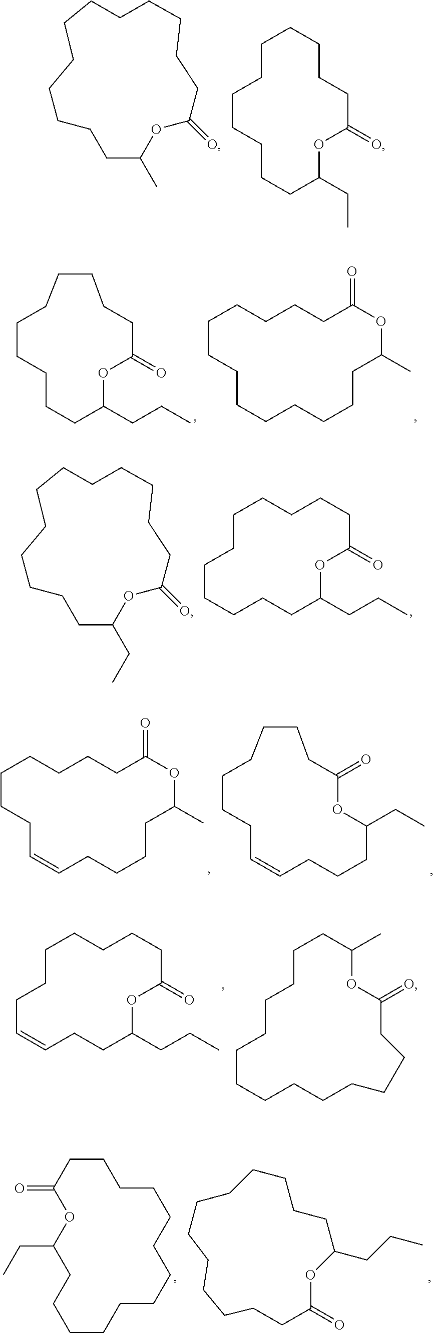

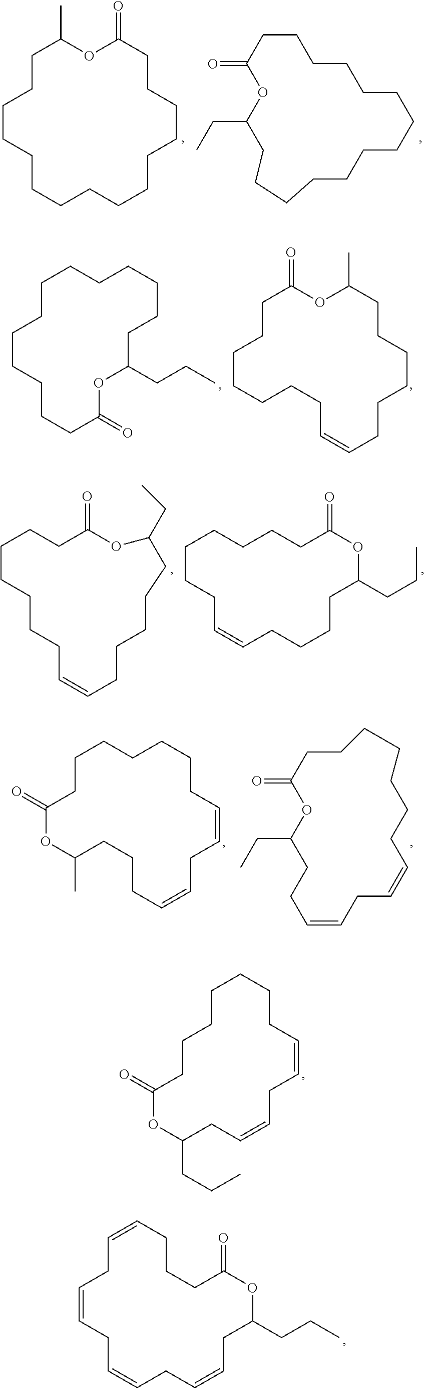

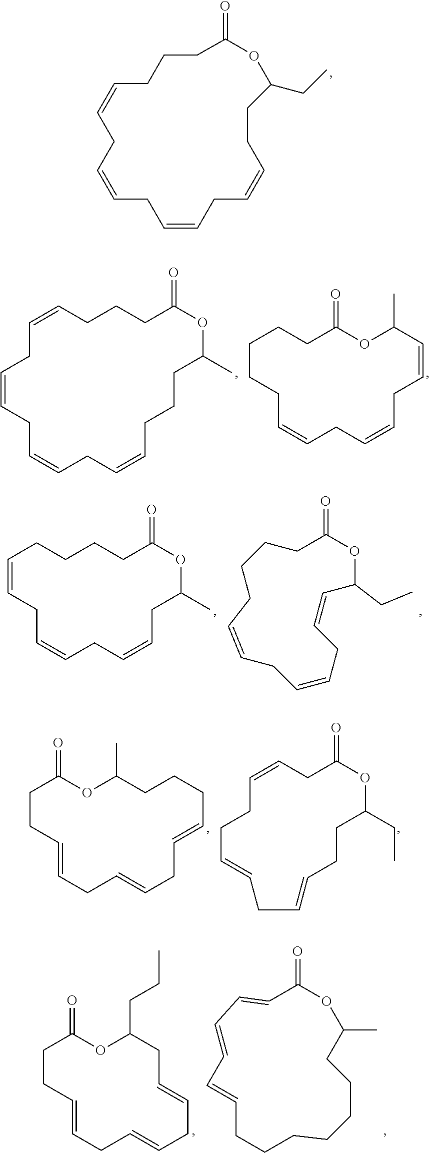

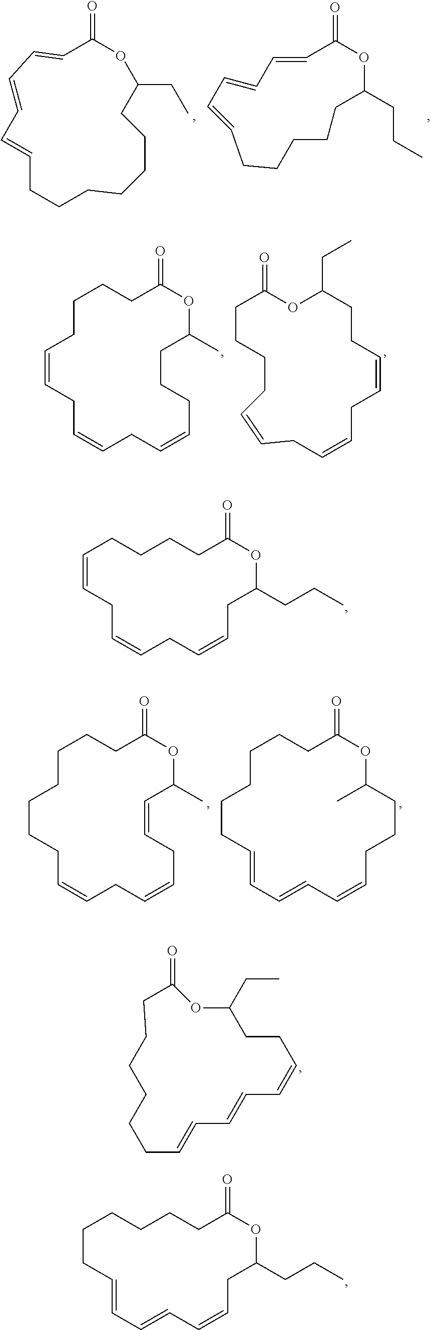

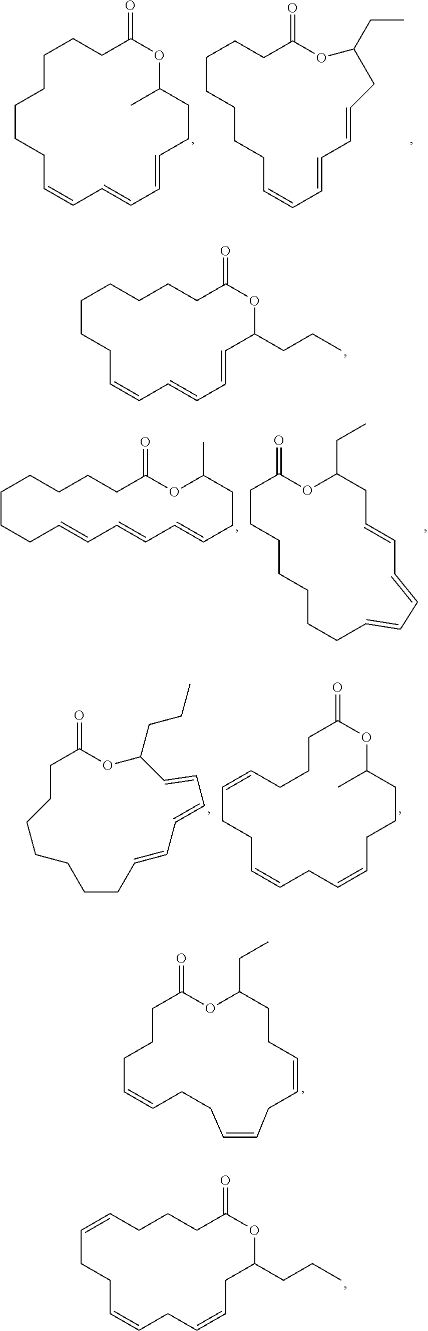

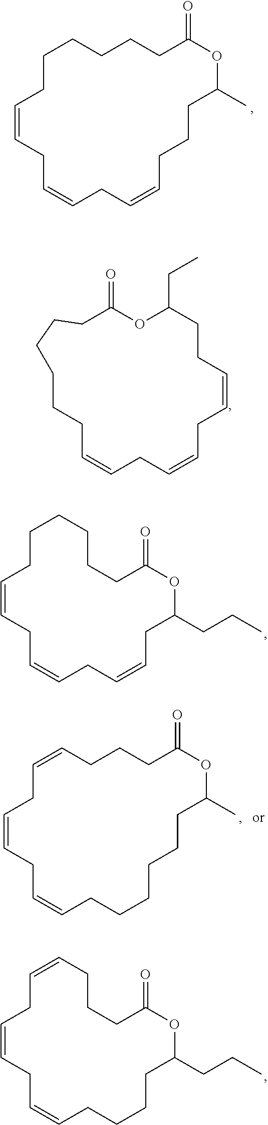

or a combination thereof,
or geometric isomers and/or stereoisomers thereof.

Embodiment XIII. The method of Embodiment XII, wherein the one or more compounds of Formula I are:

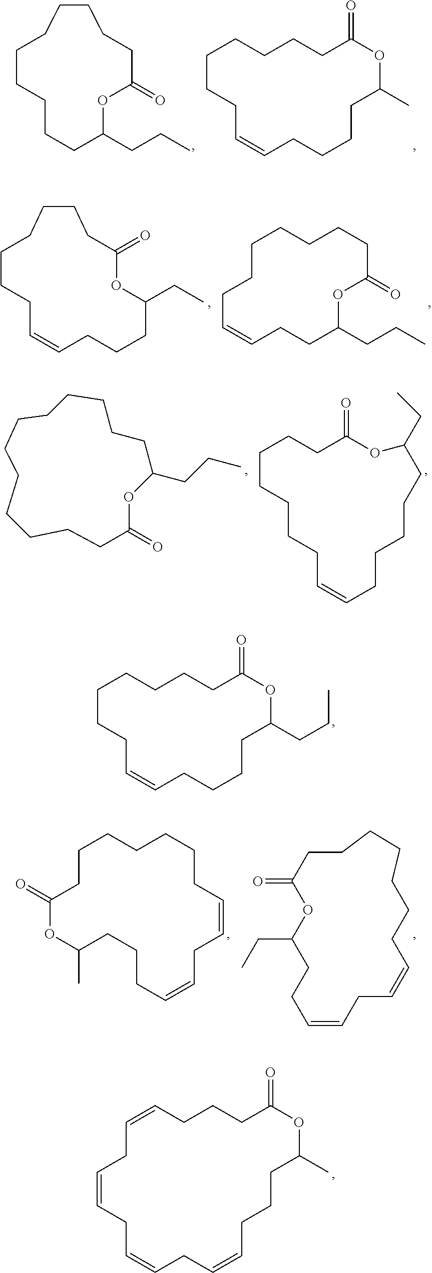

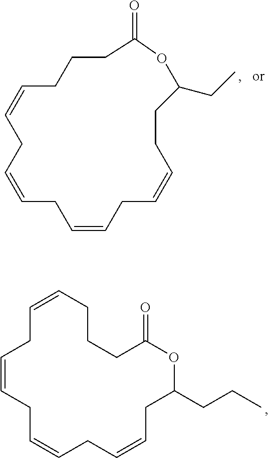 [SMILES: CCC1CC/C=C\C/C=C\C/C=C\C/C=C\CCCC(=O)O1 ; CCCC1C/C=C\C/C=C\C/C=C\C/C=C\CCCC(=O)O1]

or a combination thereof,
or geometric isomers and/or stereoisomers thereof.

Embodiment XIV. The method of Embodiment XII, wherein the one or more compounds of Formula I are:

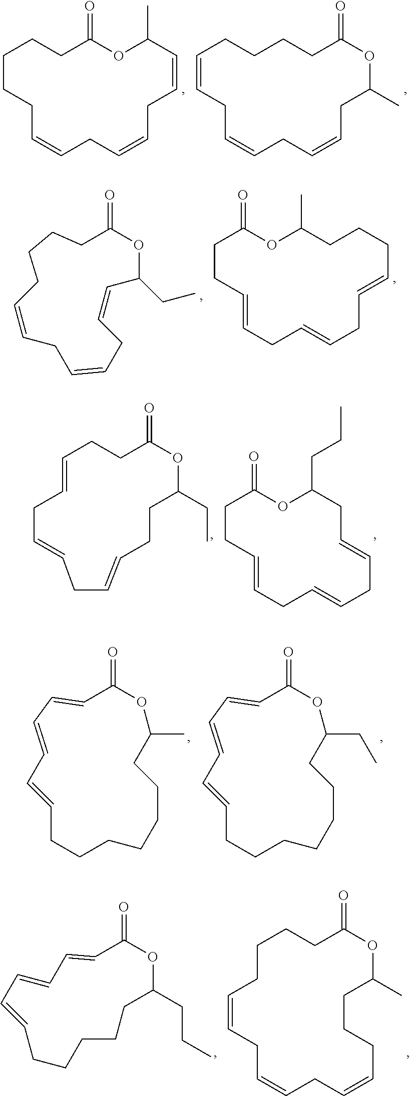

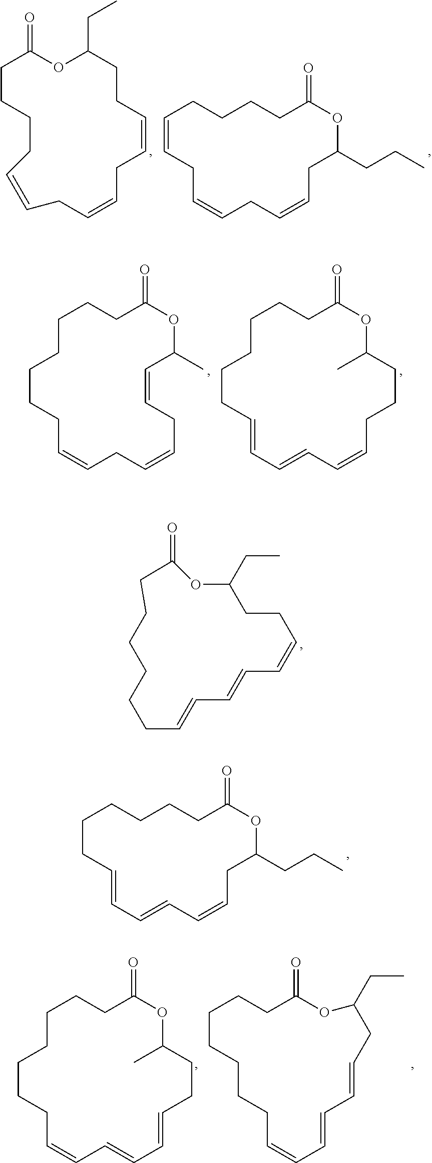

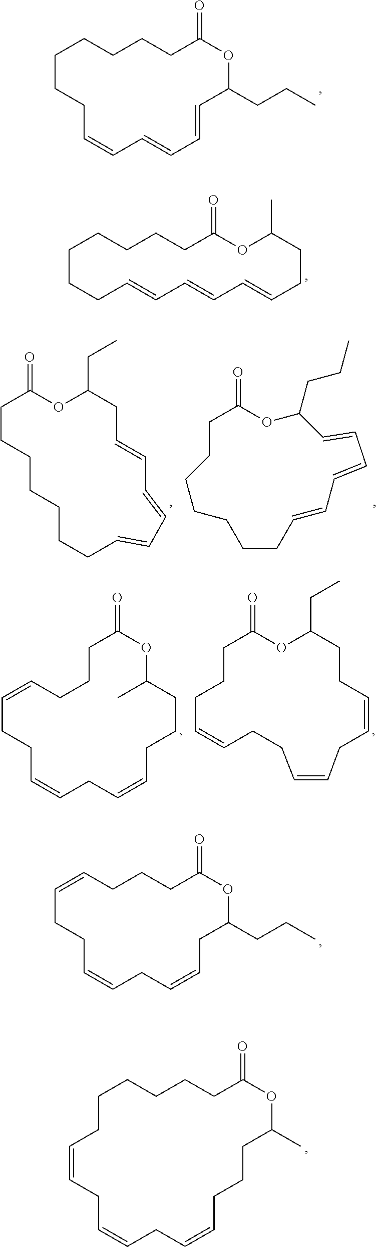

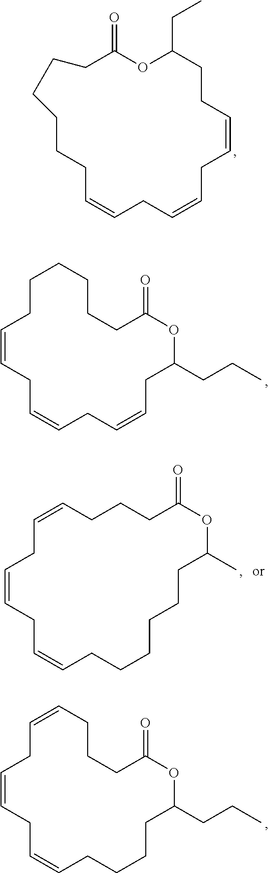

or a combination thereof,
or geometric isomers and/or stereoisomers thereof.

Embodiment XV. The method of any one of Embodiments I-XIV, wherein the composition comprises a solvent.

Embodiment XVI. The method of Embodiment XV, wherein the solvent is water, ethanol, propylene glycol, glycerin, a mid-chain triglyceride (MCT), vegetable oil, legume oil, or nut oil.

Embodiment XVII. The method of Embodiment XVI, wherein the solvent is ethanol.

Embodiment XVIII. The method of any one of Embodiments I-XVII, wherein the concentration of each of the one or more compounds in the composition is from about 0.001% w/w to about 50% w/w.

Embodiment XIX. The method of Embodiment XVIII, wherein the concentration of each of the one or more compounds in the composition is from about 0.005% w/w to about 0.1% w/w.

Embodiment XX. The method of Embodiment XIX, wherein the concentration of each of the one or more compounds in the composition is about 0.01% w/w.

Embodiment XXI. The method of any one of Embodiments I-XX, wherein from about 0.001% w/w to about 5% w/w of the composition is added to the food or beverage product.

Embodiment XXII. The method of Embodiment XXI, wherein from about 0.01% w/w to about 0.5% w/w of the composition is added to the food or beverage product.

Embodiment XXIII. The method of Embodiment XXII, wherein about 0.1% w/w of the composition is added to the food or beverage product.

Embodiment XXIV. The method of any one of Embodiments I-XXIII, wherein the food or beverage product is an alcoholic or non-alcoholic beverage, a baked good, a confectionary, a meat product, a sauce, a dressing, a dairy product, a plant-based meat product, or a plant-based dairy product.

Embodiment XXV. The method of Embodiment XXIV, wherein the food or beverage product further comprises one or more sweeteners.

Embodiment XXVI. The method of Embodiment XXV, wherein the one or more sweeteners is stevia extract, a steviol glycoside, stevioside, rebaudioside B, rebaudioside C, rebaudioside D, rebaudioside F, dulcoside A, rubusoside, steviolbioside, sucrose, high fructose com syrup, fructose, glucose, xylose, arabinose, rhamnose, erythritol, xylitol, mannitol, sorbitol, inositol, AceK, aspartame, neotame, sucralose, saccharine, naringin dihydrochalcone (NarDHC), neohesperidin dihydrochalcone (NDHC), rubusoside, mogroside 20 IV, siamenoside I, mogroside V, monatin, thaumatin, monellin, brazzein, L-alanine, glycine, Lo Han Guo, hemandulcin, phyllodulcin, or trilobtain, or a combination thereof.

Embodiment XXVII. The method of any one of Embodiments XXIV-XXVI, wherein the food or beverage product further comprises one or more acids.

Embodiment XXVIII. The method of Embodiment XXVII, wherein the one or more acids is citric acid, phosphoric acid, malic acid, tartaric acid, folic acid, fumaric acid, or lactic acid, or a combination thereof.

Embodiment XXIX. The method of any one of Embodiments XXIV-XXVIII, wherein the non-alcoholic beverage is a 5% w/w sugar solution.

Embodiment XXX. The method of Embodiment XXIX, wherein the 5% w/w sugar solution further comprises 0.08% w/w citric acid.

Embodiment XXXI. The method of any one of Embodiments XXIV-XXVIII, wherein the non-alcoholic beverage is a 0.1% w/w salt or salt substitute solution.

Embodiment XXXII. The method of any one of Embodiments XXIV-XXVIII, wherein the non-alcoholic beverage is sparkling water.

Embodiment XXXIII. The method of any one of Embodiments XXIV-XXVIII, wherein the alcoholic beverage is a 5% ABV hard seltzer.

Embodiment XXXIV. The method of any one of Embodiments XXIV-XXVIII, wherein the plant-based dairy product is almond milk, nut milk, grain milk, or legume milk.

Embodiment XXXV. The method of Embodiment XXXIV, wherein the plant-based dairy product is almond milk.

Embodiment XXXVI. The method of Embodiment XXIV, wherein the dairy product is 0% to 20% milk fat.

The disclosure also provides the following particular embodiments relating to food or beverage products comprising one or more compounds of Formula I.

Embodiment 1. A food or beverage product comprising one or more compounds of Formula I:

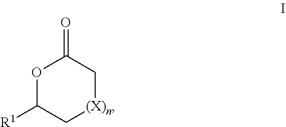

or geometric isomers and/or stereoisomers thereof, wherein:

each X is independently —CH₂—, —CH═CH—CH₂, or —C≡C—CH₂—;

R1 is C1-C6 alkyl; and

n is an integer between 6-30, inclusive.

Embodiment 2. The food or beverage product of Embodiment 1, wherein the compound of Formula I is optically inactive.

Embodiment 3. The food or beverage product of Embodiment 1, wherein the asymmetric carbon atom of Formula I is in the S configuration.

Embodiment 4. The food or beverage product of Embodiment 1, wherein the asymmetric carbon atom of Formula I is in the R configuration.

Embodiment 5. The food or beverage product of any one of Embodiments 1-4, wherein R¹ is methyl, ethyl, or propyl.

Embodiment 6 . The food or beverage product of any one of Embodiments 1-5, wherein each X is independently —CH₂— or CH═CH—CH₂—.

Embodiment 7. The food or beverage product of Embodiment 6, wherein each X is —CH₂—.

Embodiment 8. The food or beverage product of Embodiment 6, wherein one X group is —CH═CH—CH₂— and the remaining X groups are CH₂—.

Embodiment 9. The food or beverage product of Embodiment 6, wherein two X groups are —CH═CH—CH₂— and the remaining X groups are CH₂—.

Embodiment 10. The food or beverage product of Embodiment 6, wherein three X groups are —CH═CH—CH₂— and the remaining X groups are CH₂—.

Embodiment 11. The food or beverage product of Embodiment 6, wherein four X groups are —CH═CH—CH₂— and the remaining X groups are CH₂—.

Embodiment 12. The food or beverage product of Embodiment 1, wherein the one or more compounds of Formula I are:

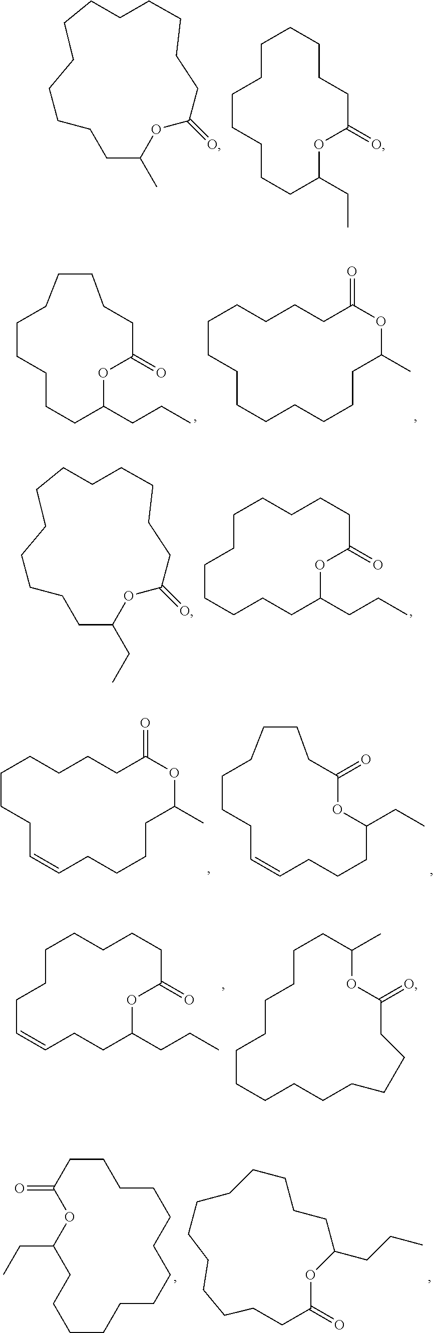

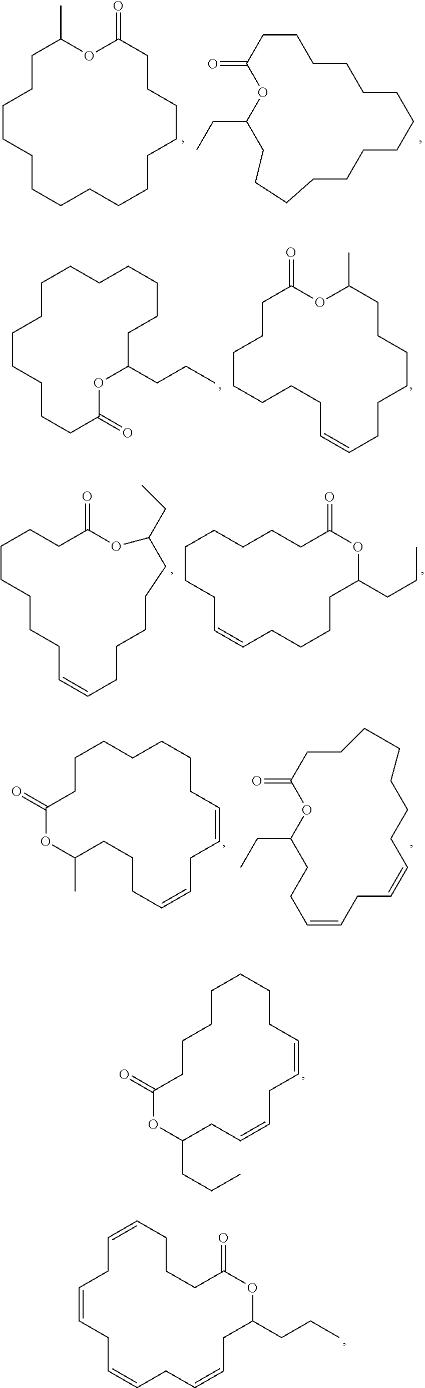

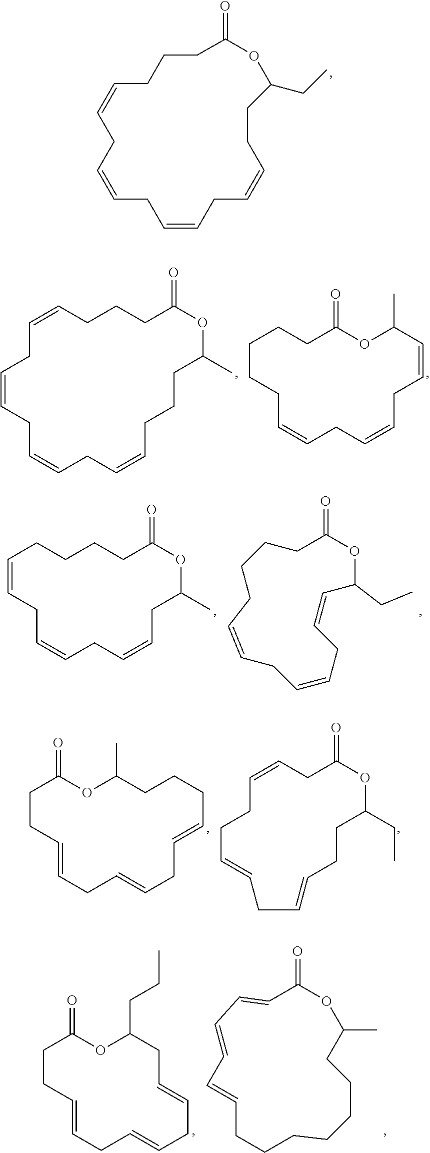

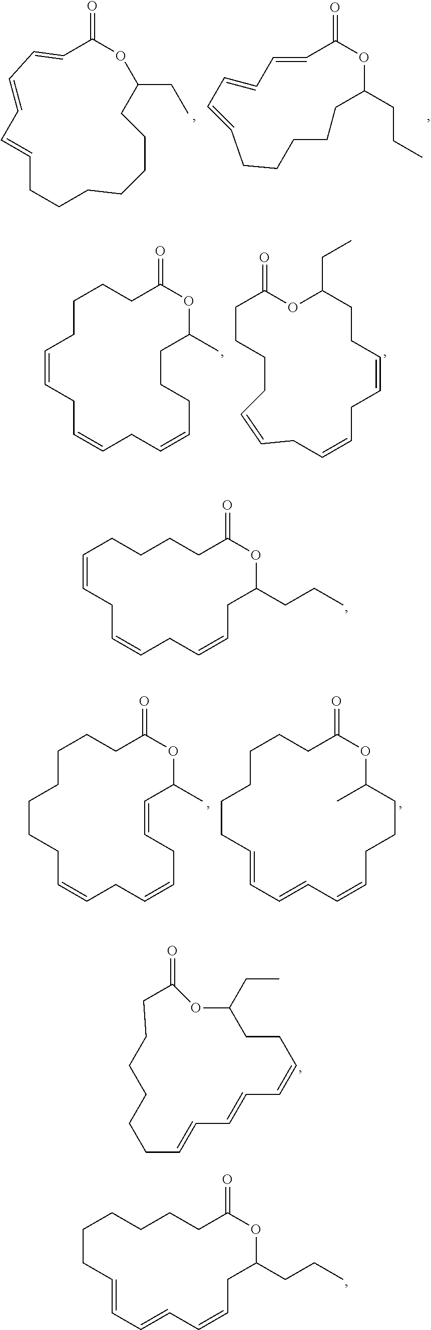

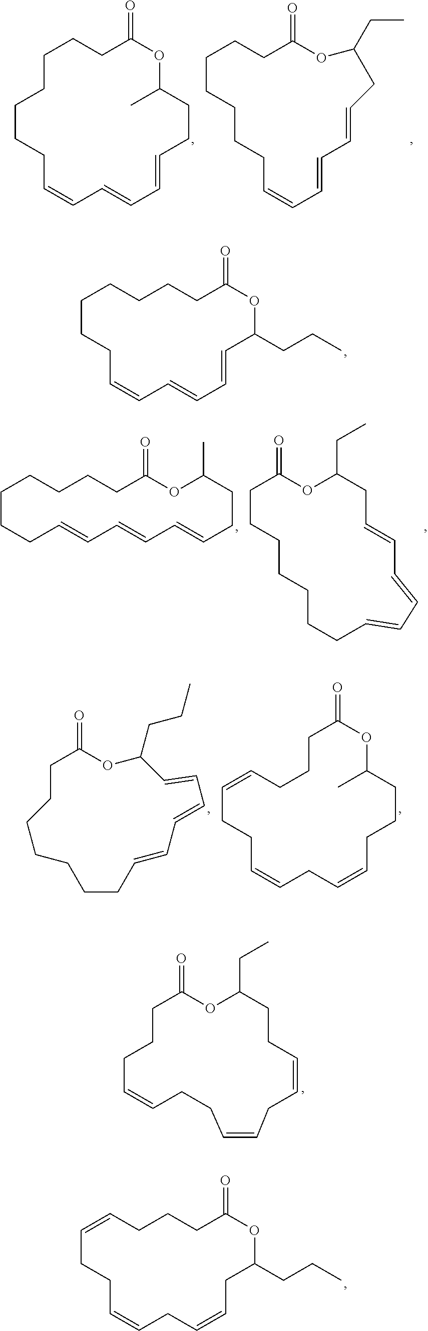

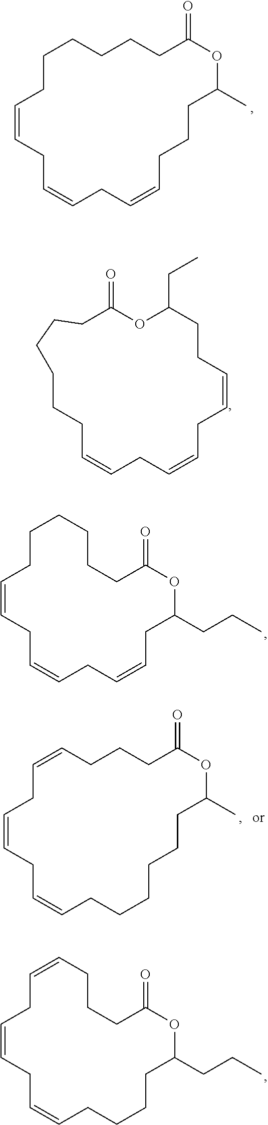

or a combination thereof,
or geometric isomers and/or stereoisomers thereof.

Embodiment 13. The food or beverage product of Embodiment 12, wherein the one or more compounds of Formula I are:

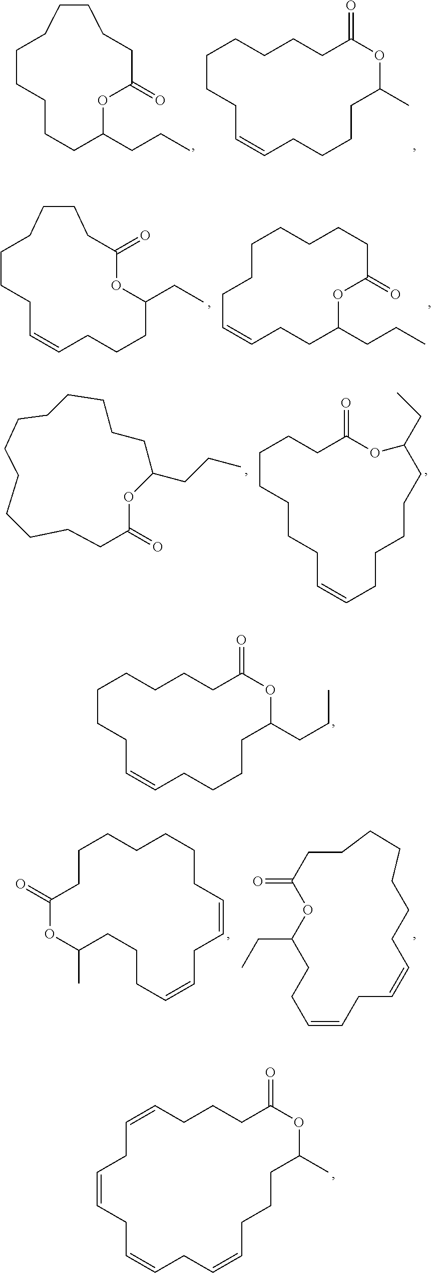

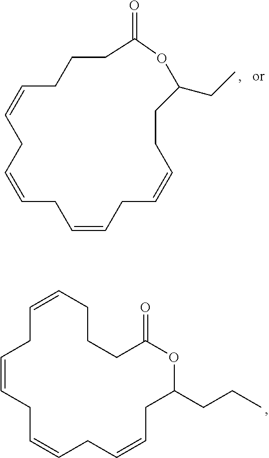 [SMILES: CCC1CC/C=C\C/C=C\C/C=C\C/C=C\CCCC(=O)O1 ; CCCC1C/C=C\C/C=C\C/C=C\C/C=C\CCCC(=O)O1]

or a combination thereof,
or geometric isomers and/or stereoisomers thereof.

Embodiment 14. The food or beverage product of Embodiment 12, wherein the one or more compounds of Formula I are:

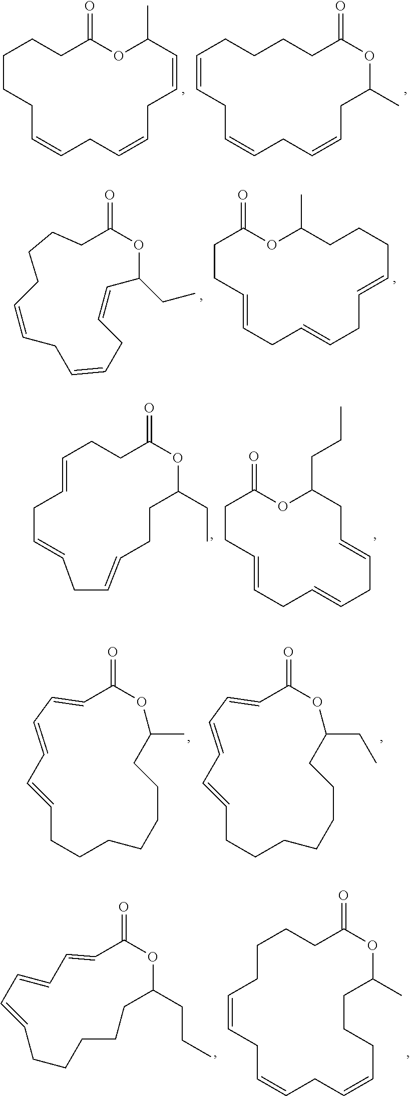

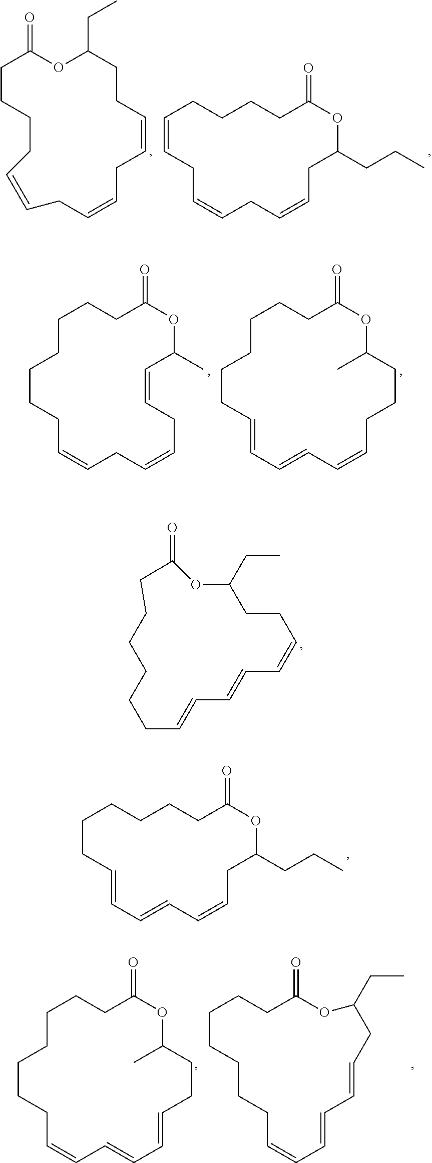

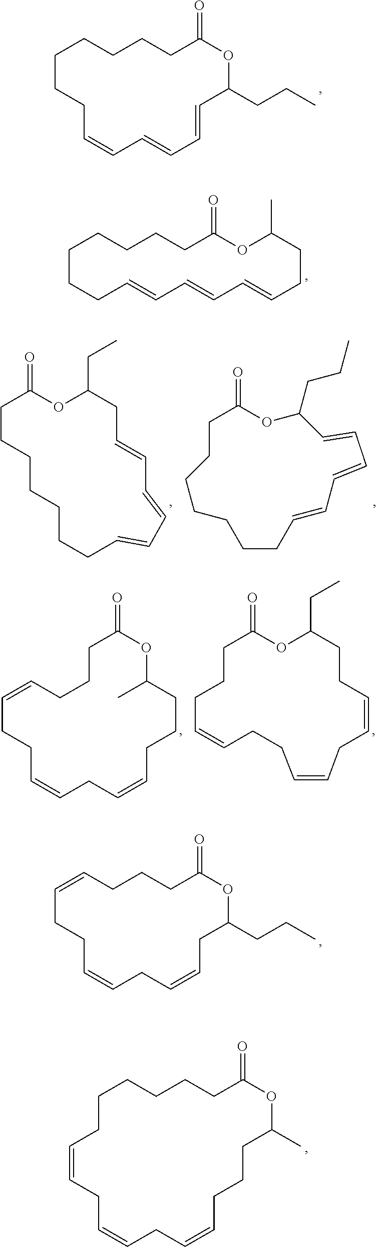

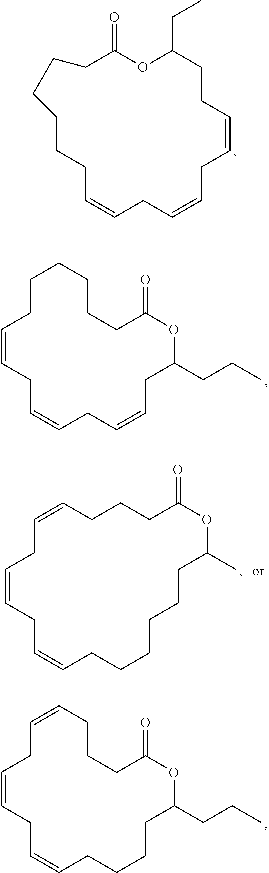

or a combination thereof,
or geometric isomers and/or stereoisomers thereof.

Embodiment 15. The food or beverage product of any one of Embodiments 1-14, wherein the food or beverage product further comprises a solvent.

Embodiment 16. The food or beverage product of Embodiment 15, wherein the solvent is water, ethanol, propylene glycol, glycerin, a mid-chain triglyceride (MCT), vegetable oil, legume oil, or nut oil.

Embodiment 17. The food or beverage product of Embodiment 16, wherein the solvent is ethanol.

Embodiment 18. The food or beverage product of any one of Embodiments 1-17, wherein the concentration of each of the one or more compounds in the food or beverage product is from about 0.0001% w/w to about 1% w/w.

Embodiment 19. The food or beverage product of Embodiment 18, wherein the concentration of each of the one or more compounds in the food or beverage product is from about 0.001% w/w to about 0.1% w/w.

Embodiment 20. The food or beverage product of Embodiment 19, wherein the concentration of each of the one or more compounds in the food or beverage product is about 0.01% w/w.

Embodiment 21. The food or beverage product of any one of Embodiments 1-20, wherein the food or beverage product further comprises one or more sweeteners.

Embodiment 22. The food or beverage product of Embodiment 21, wherein the one or more sweeteners is stevia extract, a steviol glycoside, stevioside, rebaudioside B, rebaudioside C, rebaudioside D, rebaudioside F, dulcoside A, rubusoside, steviolbioside, sucrose, high fructose com syrup, fructose, glucose, xylose, arabinose, rhamnose, erythritol, xylitol, mannitol, sorbitol, inositol, AceK, aspartame, neotame, sucralose, saccharine, naringin dihydrochalcone (NarDHC), neohesperidin dihydrochalcone (NDHC), rubusoside, mogroside 20 IV, siamenoside I, mogroside V, monatin, thaumatin, monellin, brazzein, L-alanine, glycine, Lo Han Guo, hemandulcin, phyllodulcin, or trilobtain, or a combination thereof

Embodiment 23. The food or beverage product of any one of Embodiments 1-22, wherein the food or beverage product further comprises one or more acids.

Embodiment 24. The food or beverage product of Embodiment 23, wherein the one or more acids is citric acid, phosphoric acid, malic acid, tartaric acid, folic acid, fumaric acid, or lactic acid, or a combination thereof.

Embodiment 25. The food or beverage product of any one of Embodiments 1-24, wherein the food or beverage product is an alcoholic or non-alcoholic beverage, a baked good, a confectionary, a meat product, a sauce, a dressing, a dairy product, a plant-based meat product, or a plant-based dairy product.

Embodiment 26. The food or beverage product of Embodiment 25, wherein the food or beverage product is a non-alcoholic beverage.

Embodiment 27. The food or beverage product of Embodiment 26, wherein the non-alcoholic beverage is a 5% w/w sugar solution.

Embodiment 28. The food or beverage product of Embodiment 27, wherein the 5% w/w sugar solution further comprises 0.08% w/w citric acid.

Embodiment 29. The food or beverage product of Embodiment 26, wherein the non-alcoholic beverage is a 0.1% w/w salt or salt substitute solution.

Embodiment 30. The food or beverage product of Embodiment 26, wherein the non-alcoholic beverage is sparkling water.

Embodiment 31. The food or beverage product of Embodiment 25, wherein the food or beverage product is an alcoholic beverage.

Embodiment 32. The food or beverage product of Embodiment 31, wherein the alcoholic beverage is a 5% ABV hard seltzer.

Embodiment 33. The food or beverage product of Embodiment 25, wherein the food or beverage product is a plant-based dairy product.

Embodiment 34. The food or beverage product of Embodiment 33, wherein the plant-based dairy product is almond milk, nut milk, grain milk, or legume milk.

Embodiment 35. The food or beverage product of Embodiment 34, wherein the plant-based dairy product is almond milk.

Embodiment 36. The food or beverage product of Embodiment 25, wherein the beverage product is a dairy product.

Embodiment 37. The food or beverage product of Embodiment 36, wherein the dairy product is 0% to 20% milk fat.

### EXAMPLES

### Example 1

Incorporation of Compounds of Formula I in Beverages

A compound of Formula I was dissolved in ethanol at a concentration of 0.1% w/w. The solution was further diluted into various beverages as described in Table 1.

TABLE 1

| | Amount of Solution |
|---|---|
| | of Compound of |
| Beverage | Formula I Added |
| 5% w/w sugar solution | 0.1% w/w |
| 5% w/w sugar solution | 0.1% w/w |
| with 0.08% w/w citric acid | |
| 0.1% w/w salt solution | 0.1% w/w |
| 5% ABV hard seltzer | 0.3% w/w |
| Almond milk | 0.15% w/w |
| 2% Milk Fat | 0.15% w/w |

1. A method of flavoring a food or beverage product, the method comprising admixing a composition comprising one or more compounds of Formula I: 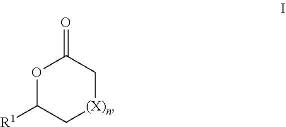
or geometric isomers and/or stereoisomers thereof, wherein:
each X is independently —CH₂—, —CH═CH—CH₂, or —C≡C—CH₂—;
R¹ is C₁-C₆ alkyl; and
n is an integer between 6-30, inclusive,
with the food or beverage product.

2.-4. (canceled)

5. The method of claim 1, wherein R¹ is methyl, ethyl, or propyl.

6.-11. (canceled)

12. The method of claim 1, wherein the one or more compounds of Formula I are: 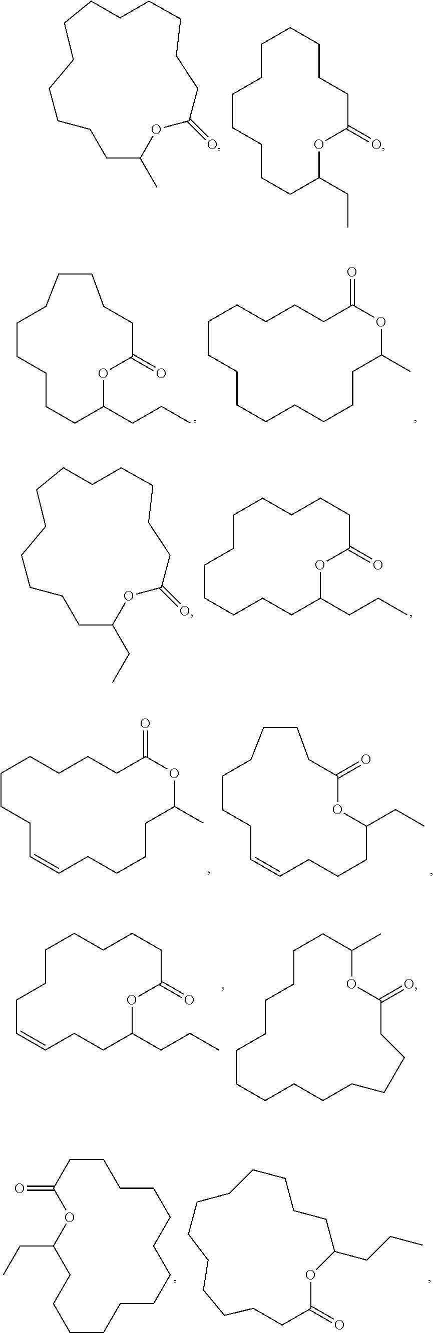 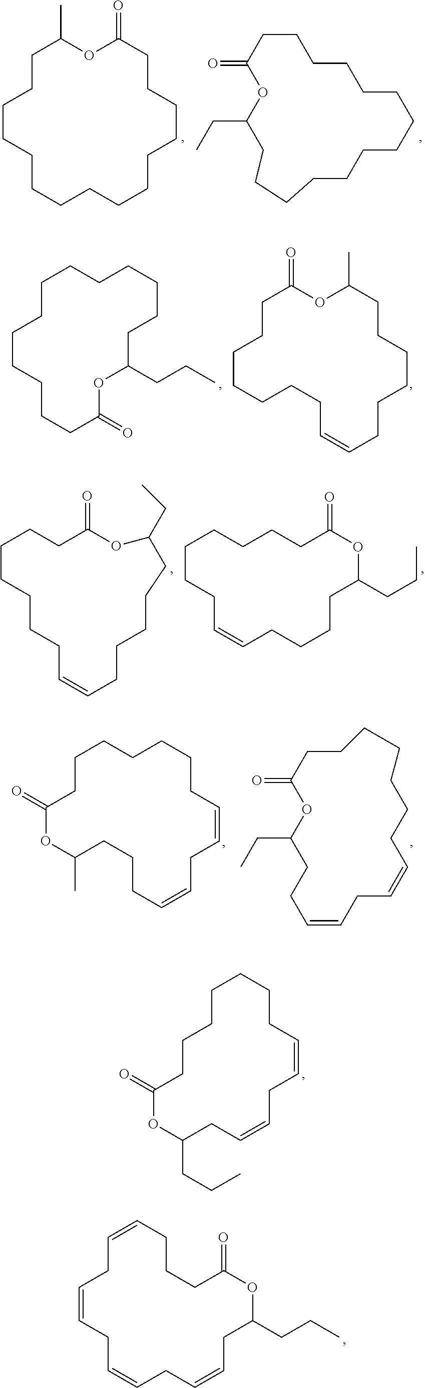 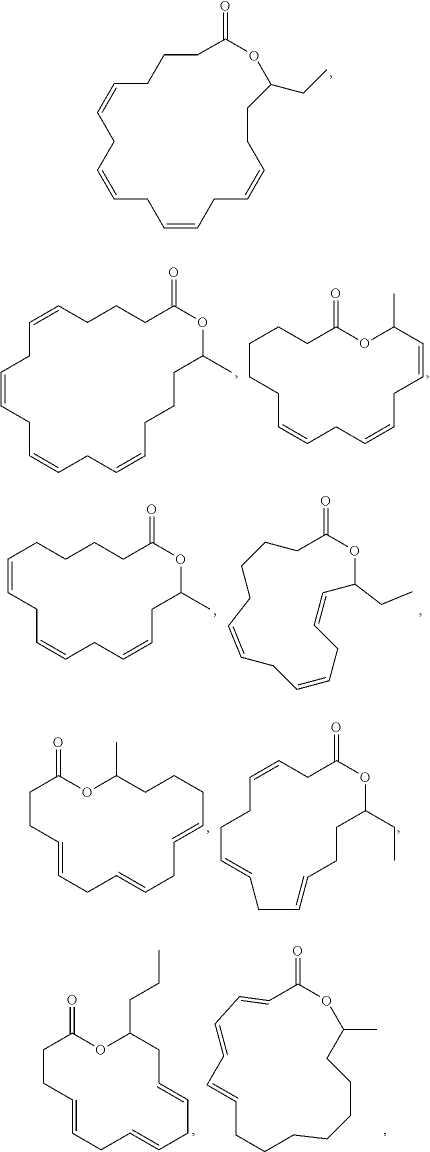 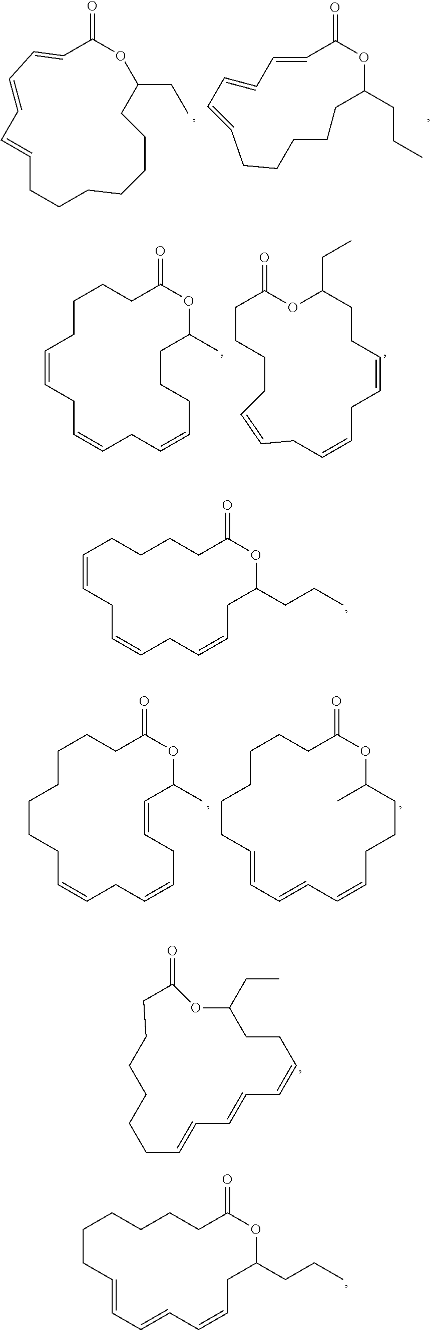 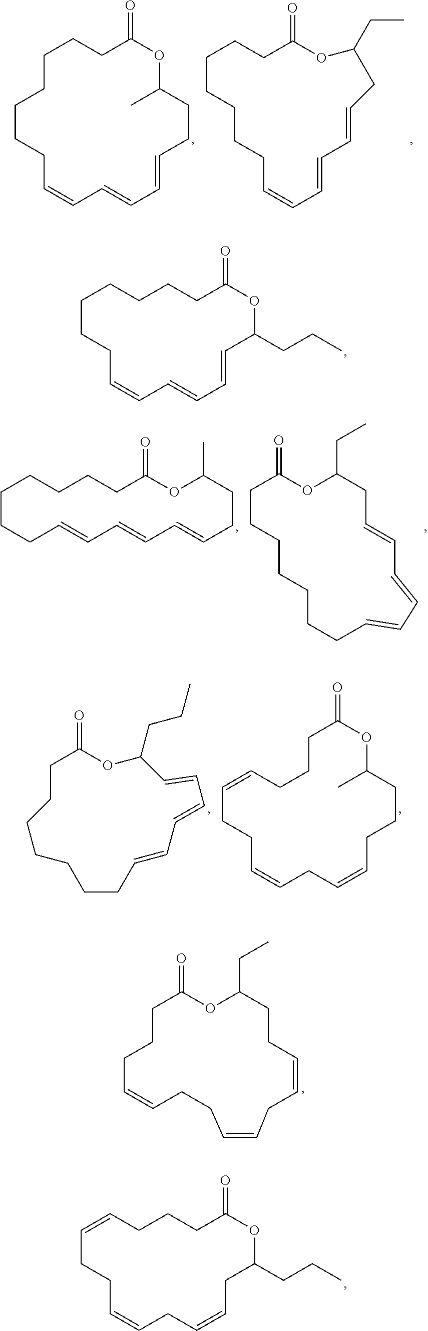 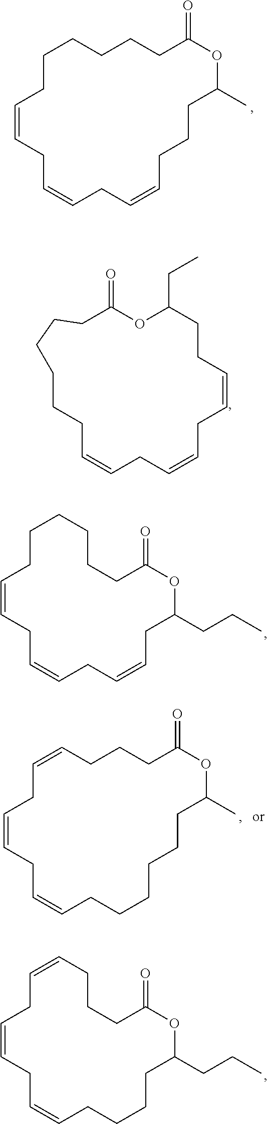
or a combination thereof,
or geometric isomers and/or stereoisomers thereof.

13. The method of claim 12, wherein the one or more compounds of Formula I are: 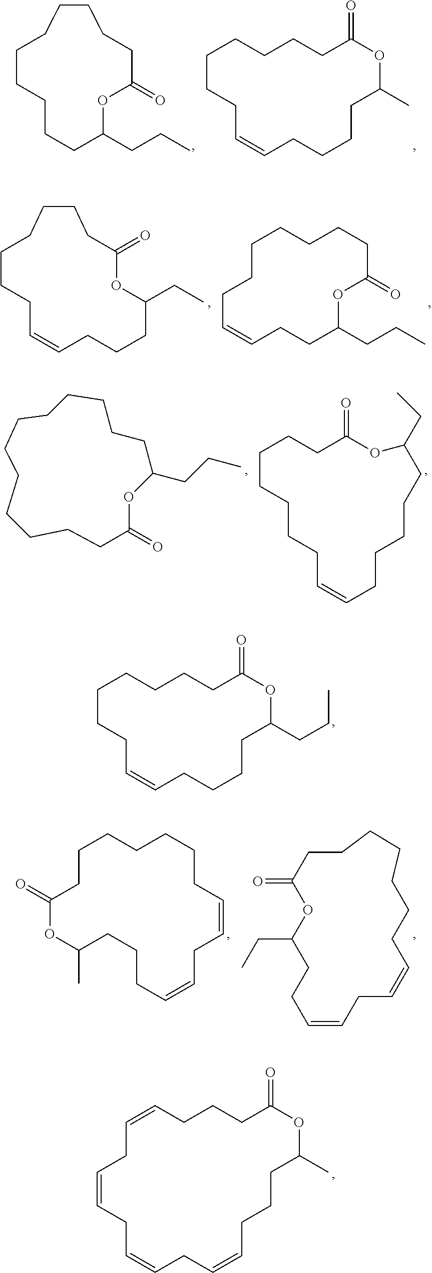 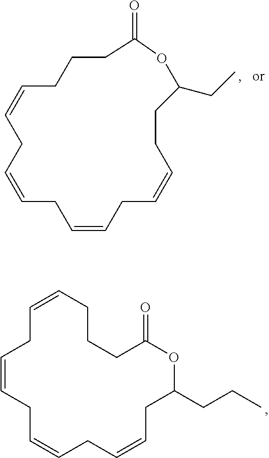 [SMILES: CCC1CC/C=C\C/C=C\C/C=C\C/C=C\CCCC(=O)O1 ; CCCC1C/C=C\C/C=C\C/C=C\C/C=C\CCCC(=O)O1]
or a combination thereof,
or geometric isomers and/or stereoisomers thereof.

14. The method of claim 12, wherein the one or more compounds of Formula I are: 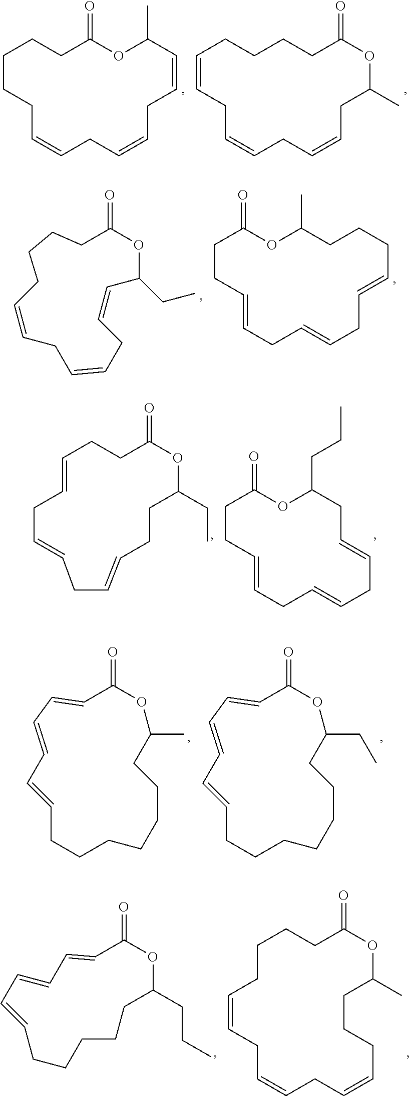 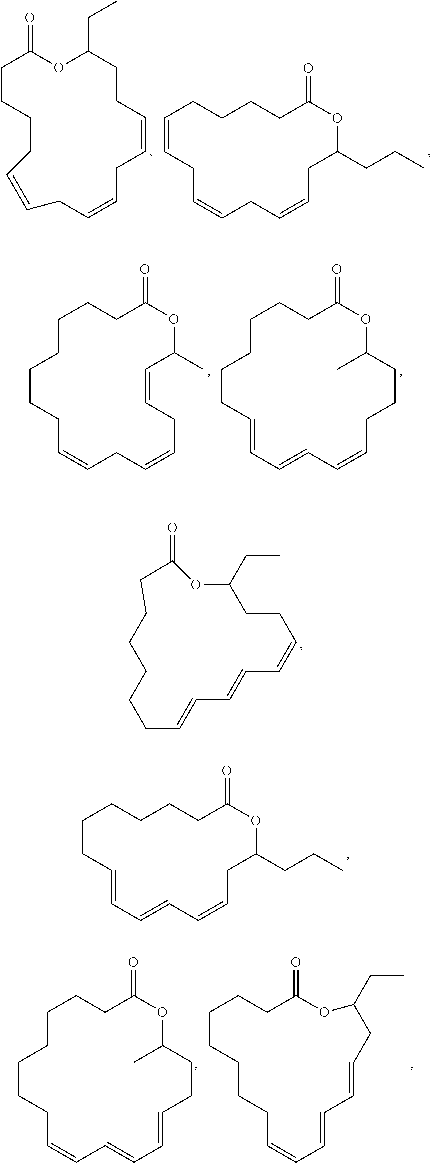 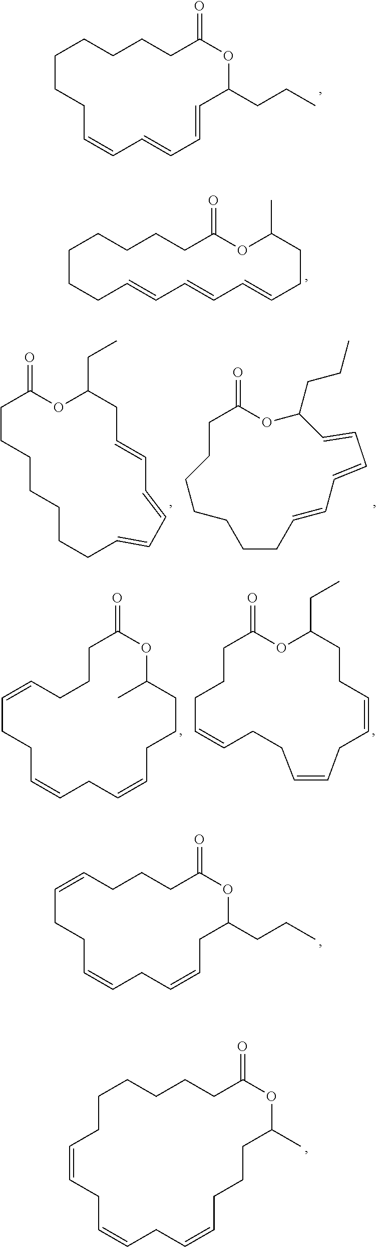 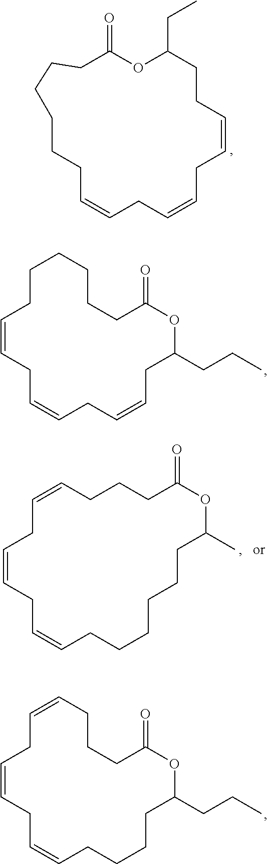 [SMILES: CCC1CC/C=C\C/C=C\C/C=C\CCCCCCC(=O)O1 ; CCCC1C/C=C\C/C=C\C/C=C\CCCCCCC(=O)O1 ; CC1CCCCCC/C=C\C/C=C\C/C=C\CCCC(=O)O1 ; CCCC1CCCC/C=C\C/C=C\C/C=C\CCCC(=O)O1]
or a combination thereof,
or geometric isomers and/or stereoisomers thereof.

15. The method of claim 1, wherein the composition comprises a solvent.

16. The method of claim 15, wherein the solvent is water, ethanol, propylene glycol, glycerin, a mid-chain triglyceride (MCT), vegetable oil, legume oil, or nut oil.

17.-18. (canceled)

19. The method of claim 1, wherein the concentration of each of the one or more compounds in the composition is from about 0.005% w/w to about 0.1% w/w.

20.-21. (canceled)

22. The method of claim 1, wherein from about 0.01% w/w to about 0.5% w/w of the composition is added to the food or beverage product.

23. (canceled)

24. The method of claim 1, wherein the food or beverage product is an alcoholic or non-alcoholic beverage, a baked good, a confectionary, a meat product, a sauce, a dressing, a dairy product, a plant-based meat product, or a plant-based dairy product.

25. The method of claim 24, wherein the food or beverage product further comprises one or more sweeteners.

26. The method of claim 25, wherein the one or more sweeteners is stevia extract, a steviol glycoside, stevioside, rebaudioside B, rebaudioside C, rebaudioside D, rebaudioside F, dulcoside A, rubusoside, steviolbioside, sucrose, high fructose corn syrup, fructose, glucose, xylose, arabinose, rhamnose, erythritol, xylitol, mannitol, sorbitol, inositol, AceK, aspartame, neotame, sucralose, saccharine, naringin dihydrochalcone (NarDHC), neohesperidin dihydrochalcone (NDHC), rubusoside, mogroside 20 IV, siamenoside I, mogroside V, monatin, thaumatin, monellin, brazzein, L-alanine, glycine, Lo Han Guo, hemandulcin, phyllodulcin, or trilobtain, or a combination thereof

27. The method of any claim 24, wherein the food or beverage product further comprises one or more acids.

28. The method of claim 27, wherein the one or more acids is citric acid, phosphoric acid, malic acid, tartaric acid, folic acid, fumaric acid, or lactic acid, or a combination thereof.

29.-33. (canceled)

34. The method of claim 24, wherein the plant-based dairy product is almond milk, nut milk, grain milk, or legume milk.

35.-36. (canceled)

37. A food or beverage product comprising one or more compounds of Formula I: 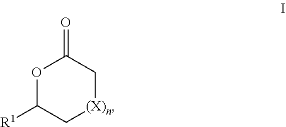
or geometric isomers and/or stereoisomers thereof, wherein:
each X is independently —CH₂—, —CH═CH—CH₂, or —C≡C—CH₂—;
R¹ is C₁-C₆ alkyl; and
n is an integer between 6-30, inclusive.

38.-40. (canceled)

41. The food or beverage product of claim 37, wherein R¹ is methyl, ethyl, or propyl.

42.-47. (canceled)

48. The food or beverage product of claim 37, wherein the one or more compounds of Formula I are: 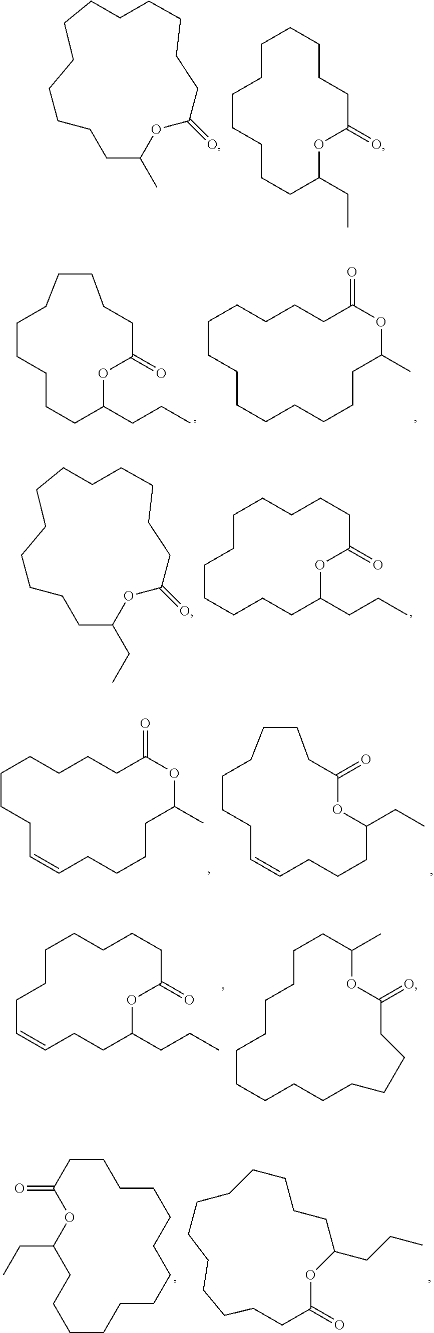 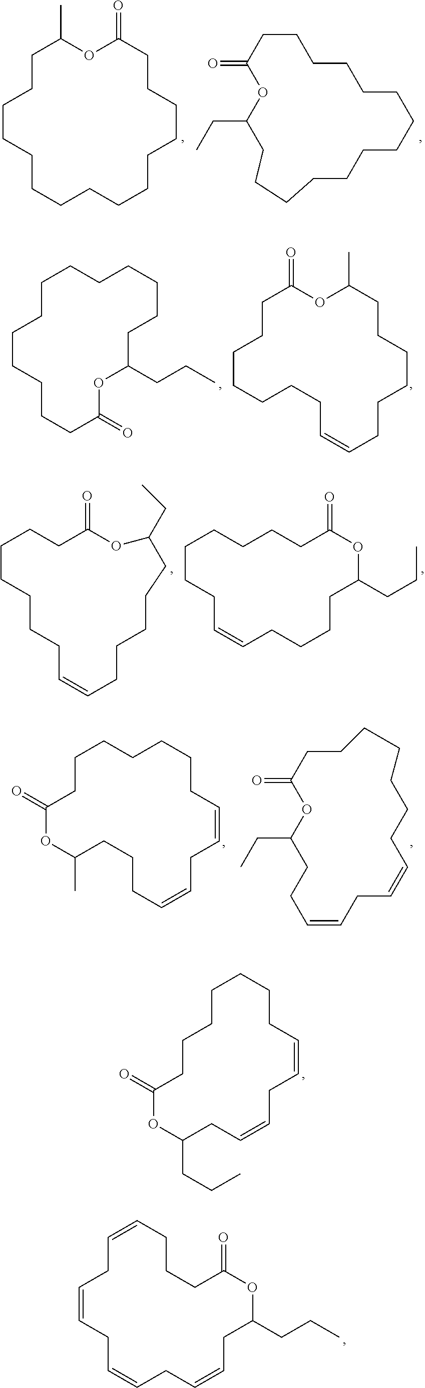 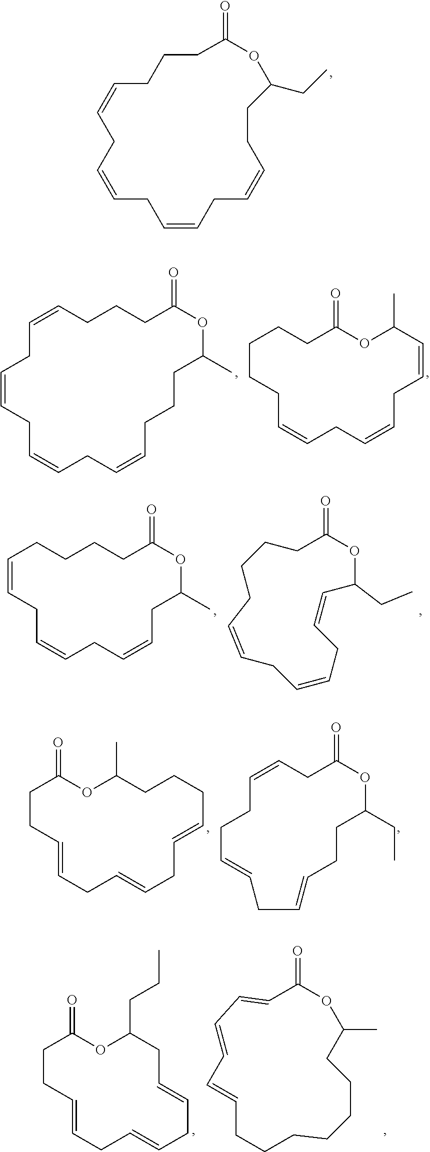 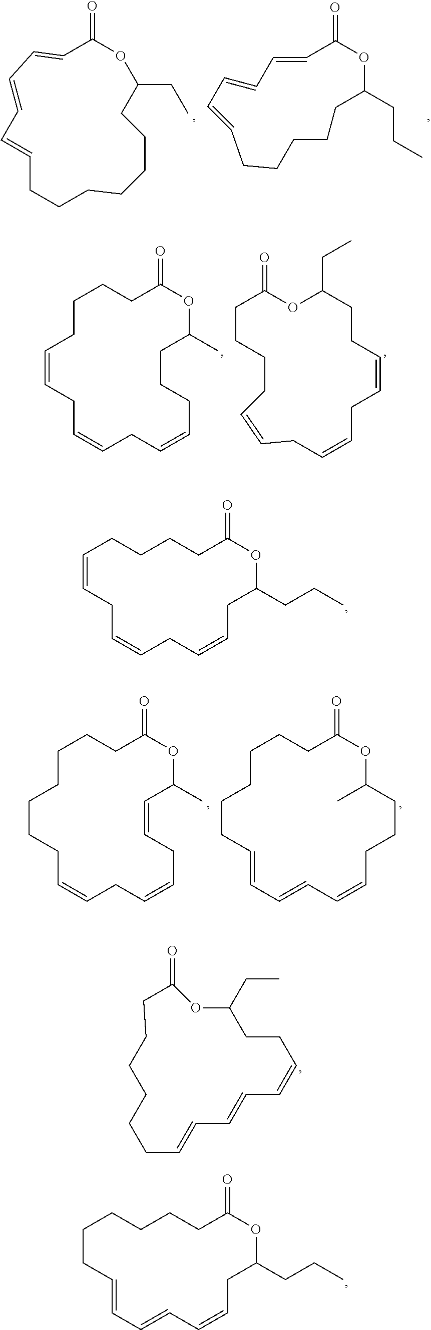 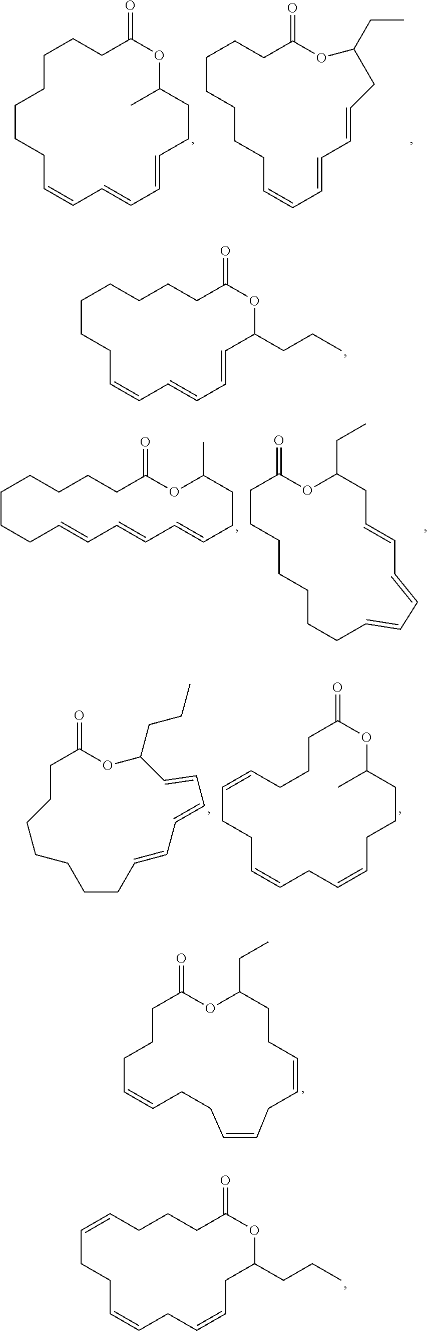 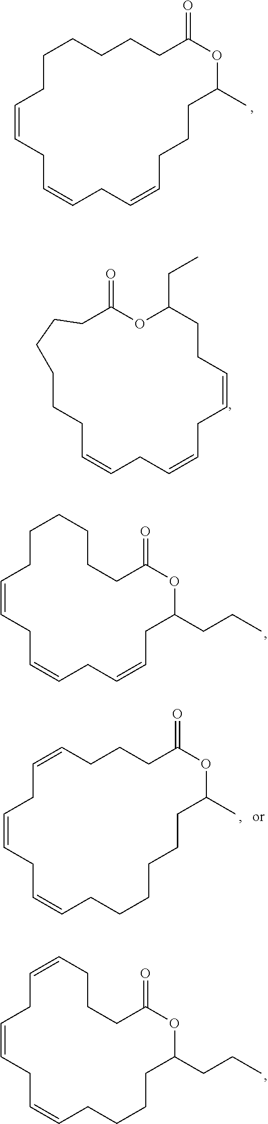
or a combination thereof,
or geometric isomers and/or stereoisomers thereof.

49. The food or beverage product of claim 48, wherein the one or more compounds of Formula I are: 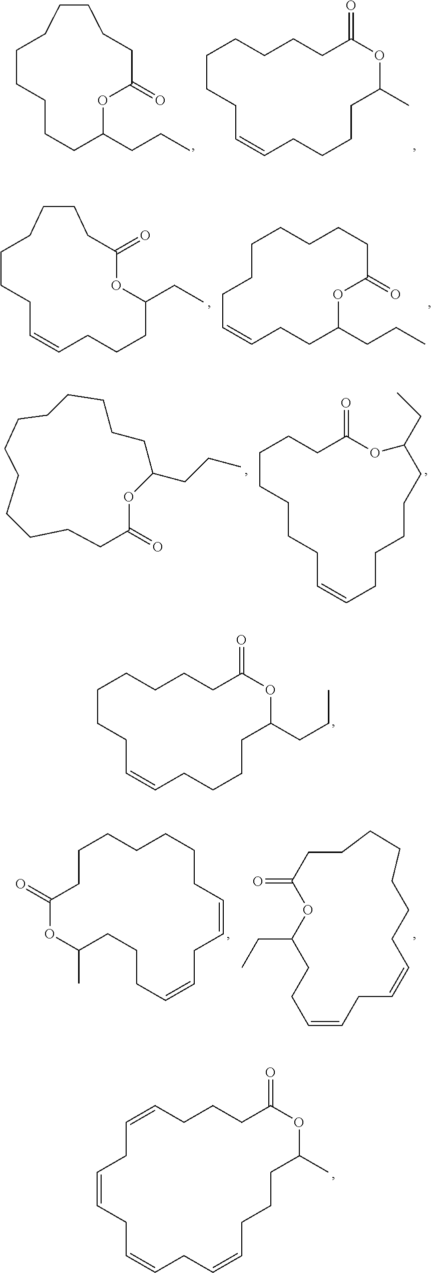 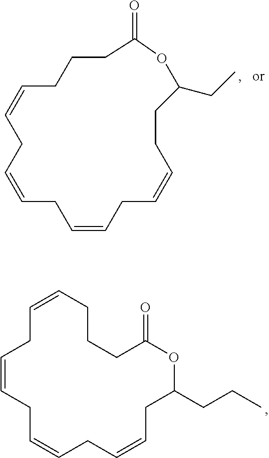 [SMILES: CCC1CC/C=C\C/C=C\C/C=C\C/C=C\CCCC(=O)O1 ; CCCC1C/C=C\C/C=C\C/C=C\C/C=C\CCCC(=O)O1]
or a combination thereof,
or geometric isomers and/or stereoisomers thereof.

50. The food or beverage product of claim 48, wherein the one or more compounds of Formula I are: 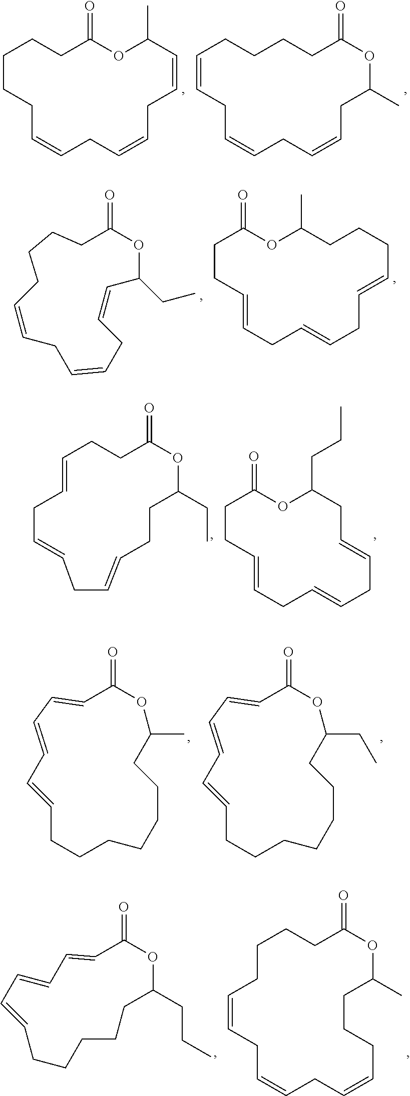 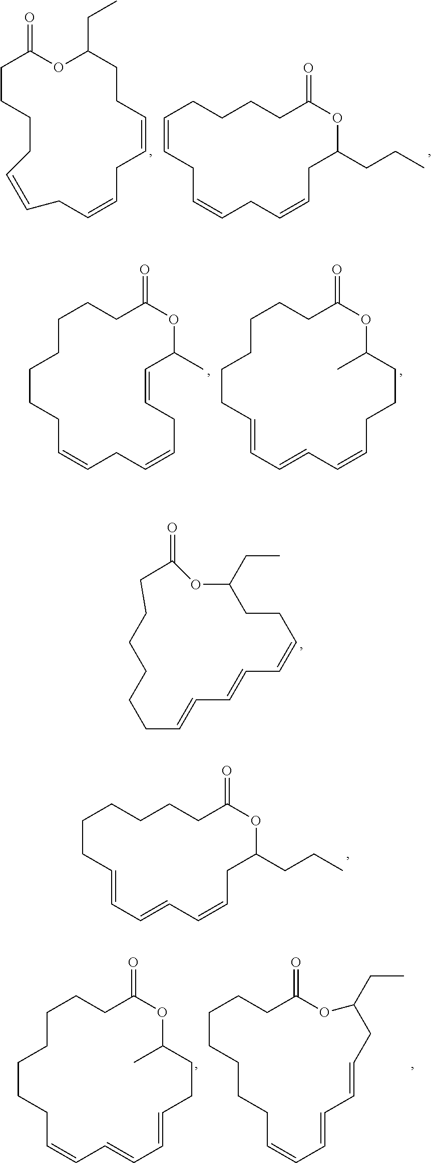 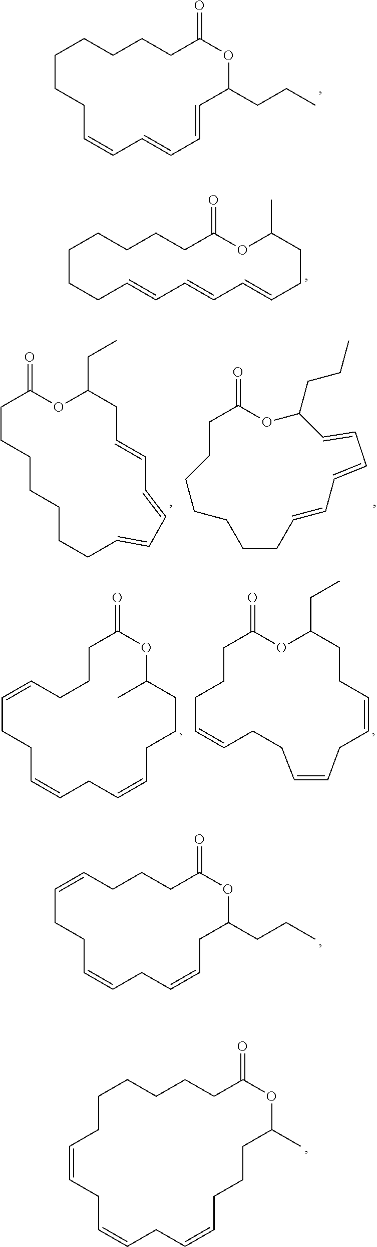 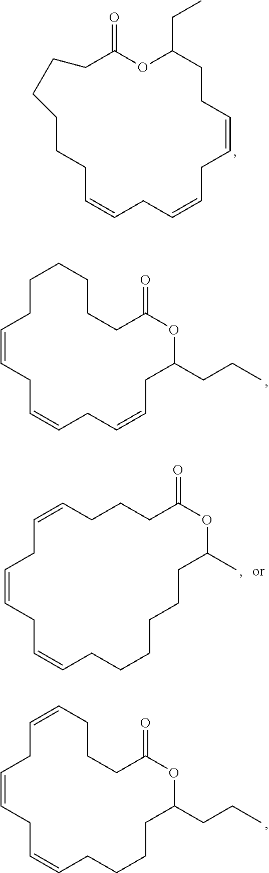
or a combination thereof,
or geometric isomers and/or stereoisomers thereof.

51. The food or beverage product of claim 37, wherein the food or beverage product further comprises a solvent.

52. The food or beverage product of claim 51, wherein the solvent is water, ethanol, propylene glycol, glycerin, a mid-chain triglyceride (MCT), vegetable oil, legume oil, or nut oil.

53.-54. (canceled)

55. The food or beverage product of claim 37, wherein the concentration of each of the one or more compounds in the food or beverage product is from about 0.001% w/w to about 0.1% w/w.

56. (canceled)

57. The food or beverage product of claim 37, wherein the food or beverage product further comprises one or more sweeteners.

58. The food or beverage product of claim 57, wherein the one or more sweeteners is stevia extract, a steviol glycoside, stevioside, rebaudioside B, rebaudioside C, rebaudioside D, rebaudioside F, dulcoside A, rubusoside, steviolbioside, sucrose, high fructose corn syrup, fructose, glucose, xylose, arabinose, rhamnose, erythritol, xylitol, mannitol, sorbitol, inositol, AceK, aspartame, neotame, sucralose, saccharine, naringin dihydrochalcone (NarDHC), neohesperidin dihydrochalcone (NDHC), rubusoside, mogroside 20 IV, siamenoside I, mogroside V, monatin, thaumatin, monellin, brazzein, L-alanine, glycine, Lo Han Guo, hemandulcin, phyllodulcin, or trilobtain, or a combination thereof

59. The food or beverage product of claim 37, wherein the food or beverage product further comprises one or more acids.

60. The food or beverage product of claim 59, wherein the one or more acids is citric acid, phosphoric acid, malic acid, tartaric acid, folic acid, fumaric acid, or lactic acid, or a combination thereof.

61. The food or beverage product of claim 37, wherein the food or beverage product is an alcoholic or non-alcoholic beverage, a baked good, a confectionary, a meat product, a sauce, a dressing, a dairy product, a plant-based meat product, or a plant-based dairy product.

62.-69. (canceled)

70. The food or beverage product of claim 61, wherein the plant-based dairy product is almond milk, nut milk, grain milk, or legume milk.

71. (canceled)

72. The food or beverage product of claim 61, wherein the beverage product is a dairy product.

73. (canceled)
